(19) United States
(12) Patent Application Publication
(10) Pub. No.: US 2006/0285436 A1
(43) Pub. Date: Dec. 21, 2006

(54) Intelligent system for use in subterranean drilling applications

(76) Inventors: Rene Virgillo Mayorga Lopez, Regina (SK); Agustin Jose Bastardo Rangel, Regina (SK)

Correspondence Address: FROST BROWN TODD, LLC, 2200 PNC CENTER, 201 E. FIFTH STREET, CINCINNATI, OH, 45202, US

(21) Appl. No.: 11/447,681

(22) Filed: Jun. 6, 2006

Related U.S. Application Data
(60) Provisional application No. 60/687,761, filed on Jun. 6, 2005.

(51) Int. Cl. G01V 1/00

(52) U.S. Cl. 367/27

(57) ABSTRACT

A method and apparatus for the onsite assessment of sensory data during the drilling of a subterranean well to determine when a drilling tool has reached an optimal drilling terminus. One or more sensory data streams are captured and monitored by a terminus decision module, which identifies the appropriate combinations of sensory readings which might indicate that the drilling tool has reached an optimal drilling terminus. The terminus decision module might be either a coded formula-based software component, or might use a fuzzy inference or “fozzy logic” system in the assessment of sensory data. The need for offsite or offline engineering assistance is removed. In addition to the method, both a stand-alone apparatus as well as an add-on instrumentation kit for a PC otherwise in use at the drilling site are disclosed. The system of the present invention could be used in single or multi-axis drilling applications, and could be integrated with the depth or location control system for the drilling tool to automatically adjust the positioning or attributes of the tool.

This invention is in the field of subterranean (inland and/or offshore) drilling in, for example, oil and gas applications. More specifically, the invention relates to an optimized and automated method for determining the suitability of a particular location of a drilling tool within a well being drilled as a terminus for the drilling of the well, based on the automated assessment of one or more sensory data streams.

### BACKGROUND

Subterranean drilling for natural resources such as oil or natural gas is a complex process. Getting a well drilled to the appropriate depth, in the appropriate location and at a minimum of wasted cost and resources is the objective of drilling service companies, and it is against this background that the present invention is conceived.

Effectively, the main decision which needs to be made in the placement and drilling of an oil or gas well is to find where recoverable oil or gas really is in the earth and then get the drilling tool to that location at a minimum of cost and maximum time efficiency. Typically before a drilling company would start the drilling of an oil well, the soils would be explored using techniques such as seismology, satellite imagery, or other detection devices which can effectively determine the presence of hydrocarbons in the soil, etc. These techniques give a general idea where oil might be located, which for the sake of this discussion will be referred to as a predetermined drilling site. A drilling rig is then erected at the predetermined drilling site and drilling is commenced with a view to getting to the oil or gas deposit.

Normally and conventionally the rig would drill down to a predetermined logging location, where the drilling is temporarily stopped and through a logging process the soils or terrain surrounding the drilling tool or the well as drilled so far can be measured and data recovered. Samples or data which are collected are then sent to offsite geologists for remote assessment. The exploration stage only gives a general idea of the location of the oil and it is necessary, through this geological assessment process on an ongoing basis as drilling takes place in the conventional method, to continually assess the proximity of the drilling tool to an oil or gas location. Once from the remote assessment of the data it is determined that the well has been drilled to an appropriate depth, drilling can be stopped and conventional extraction commenced if the well is going to be capable of extraction or the well abandoned if it determined at some point the well is not suitable for economically feasible oil or gas extraction.

Predetermined logging depths for a well are determined by geologists in advance of the drilling or as drilling is conducted, based on the general data obtained in advance of drilling, and/or might be altered based on data obtained during the drilling process.

Collecting logging data at a shutdown point at a predetermined logging location is obviously a very expensive approach to be used in the field.

In the remote geology lab, the geologists receive the information from the oil fields and then they analyze it and send the results back. As can be seen in the following Figure, these labs are receiving continuous information from many oil fields, which causes delays in the oil drilling operations.

[image]

The delays on the oil drilling operations could be hours or days depending on how much information the geologists have to process. Also, another factor that causes delays in the data analysis is the quality of the information that is received by the lab. Sometimes the geologists do not get enough accurate information from the oil fields. In order to make decisions about the oil wells, the geologists must have sufficient information about them. When the geologists consider that there is not enough information, they ask the crew who are in the oil fields to get more data from the soils and send it to them. All these delays increase the costs of the operation.

The problem which has been identified, then, with respect to oil drilling operations which it is proposed to address with the present invention is the problem of the excessive time and costs involved with offsite assessment of geological data and sample results obtained from particular predetermined drilling depths in a subterranean well as it is being drilled. It would be optimal to be able to assess those data and sample results onsite rather than at an offsite lab or remote center, since not only would there potentially be a quicker turnaround, but also the data from the particular site in question would not compete for priority and resources with the data from multiple other sites being handled by the same remote center.

Shutdowns could be shortened or avoided and overall costs of drilling operations could be significantly decreased if it were possible to arrive at some type of an automated process for the onsite or online assessment of sensory data.

### SUMMARY OF THE INVENTION

It is the object of the present invention to overcome shortcomings in the prior art with respect to the analysis of sensory data pertaining to the drilling of oil and gas and other subterranean wells.

It is a further object of the present invention to provide a method and apparatus which can be used in the on-site analysis of sensory data collected by a sensing or logging process with respect to a subterranean well as it is drilled, for the purpose of assessing the propriety of the location of the drilling tool as a beneficial terminus for the well. By analyzing logging data or drilling data from sensors used within the well on-site at the drilling rig, rather than sending it to a remote geologist or geology lab, drilling delays and costs can be minimized.

It is the further object of the present invention to provide a system and apparatus which can be used on-site for the online assessment of sample or sensory data obtained as the logging process proceeds down to a predetermined logging location, wherein the captured drilling sensory data are analyzed on an ongoing or streamed basis during drilling operations. This would effectively allow for the on-site and real time assessment of drilling results without requiring a drilling shutdown for the on-site assessment of the information in question.

It is contemplated that the present invention could be useful in a number of different applications. Firstly, while the applications in which the present invention can be used are referred to herein as “subterranean” drilling applications, the present invention could be used in and is intended to encompass both onshore and offshore drilling. There would be no major changes required to the method or system of the present invention in order to practice the method in an offshore well as compared to an onshore or inland well, and it is contemplated that the use of an on-site and local data capture and analysis process or method such as is proposed herein in either in offshore or in inland application would be beneficial.

It has been outlined in further detail elsewhere herein that the method and apparatus of the present invention could be used to analyze sensory data with respect to the drilling of the oil well which was being drilled either on a single axis or on a multiple axis basis. Specifically, a well which is being drilled straight down or on a vertical could be analyzed using the method and apparatus of the present invention, as could a well which is being drilled either in a “horizontal” fashion or alternatively on some type of a multiple axis basis. It will be understood that the use of the method of the present invention in either a single or multiple axis drilling application is contemplated within the scope of the present invention. As long as the drilling sensors which were used were capable of capturing, and the drilling database capable of recording, the necessary coordinates or information to provide specific location references corresponding to the various sensory data captured to the drilling database, the number of axes of operation of the drilling tool would not matter to the effective operation of the system or invention and infect the present invention may be of increased or significant utility in a multiple axis drilling application.

The invention addresses problems in the prior art by first comprising or providing a method of locating a drilling terminus during the drilling of a subterranean well and a predetermined drilling site using a drilling tool. The first step of that method of the present invention is a data capture step, which comprises during the drilling of the well capturing at least one drilling data stream, which comprises sensory drilling data from at least one drilling sensor within the well, and saving that drilling data with reference to the specific location within the well at which such drilling data was captured to a drilling database which is resident upon a computer interfaced to the drilling sensor or sensors in question. The second step in the method of the present invention is a data analysis step which comprises, using a site computer located at the drilling site and software thereon which comprises at least a terminus decision module, assessing the desirability of specific locations within the well as drilling termini based upon the comparison of the location referenced drilling data with respect to each such specific location contained within the drilling database to at least one terminus decision criteria. Using this method of locating a drilling terminus, drilling of the well can be altered based upon the determination during the data analysis step that a desired drilling terminus has not yet been reached, or else drilling of the well could be stopped based upon the determination during the data analysis step of the specific location within the well which has been reached by the drilling tool comprises the desired drilling terminus at which point in time the well could be terminated, the tools withdrawn and conventional recovery techniques commenced.

The actual drilling of the well itself might comprise a dependent step in the process, but in its broadest sense the method of locating a drilling terminus which is outlined herein is intended to comprise solely the sensory data capture to a locally hosted drilling database of at least one sensory data stream related to the geology or characteristics of a subterranean well as it is being drilled, and based upon the sensory data captured in that regard rendering some determination as to whether or not an appropriate or desirable terminus for the well has been reached or not, and providing some type of a user output or interface by which that comparison of the results of that comparison can be action by the drilling equipment or the operators of the drilling equipment of the subterranean well in question.

The method of the present invention, insofar as it comprises a data analysis step and a data capture step, might have the steps conducted in different orders or at the same time. For example, the data analysis step might, in an “off-line” embodiment, take place after the completion of the data capture step. This might be a circumstance in which all of the sensory data with respect to a particular section of the well was first captured to a drilling database and then the terminus decision module software was used to assess all of that data or information at the same time and decide whether or not any of the specific locations which that data pertained to comprised a suitable terminus for the well. In an “online” embodiment, the data capture step and the data analysis step could take place coincidentally, that is to say that the terminus decision module could conduct an ongoing assessment of the drilling data as it was captured to the drilling database, and effectively data could be captured at the same time as the data captured to the database was being assessed. In the circumstance where the data capture step and the data analysis step were taking place coincidentally, it is further contemplated that the data capture step and the data analysis step could take place coincidentally either at the time that the drilling tool was in operation within the well, or alternatively in a more conventional embodiment with the drilling tool having been removed from the well, and the drilling sensor or sensors being inserted therein in its place.

As outlined elsewhere herein, the method of assessment of the present invention might include, at the conclusion of the data analysis step, displaying the results thereof with respect to the propriety of certain locations within the well as a terminus for the well to human users by way of a conventional human computer interface such as a monitor, printed report or the like. In another embodiment the method might include, either rather than a human display or in addition to a human display, sending instructions to the drilling equipment by way of a drilling tool control interface based upon the results or calculations rendered by the terminus decision module.

The drilling database which is used by the method of the present invention might either be hosted upon the site computer itself or alternatively upon another computer located at the drilling site which was networked or operatively connected to the site computer so that the software on the site computer, and specifically the terminus decision module, could access the contents of the drilling database.

The method of the present invention further addresses the problems or limitations in the prior art by allowing in certain embodiments for the triggering of the cessation of drilling upon the determination by the system and method that the desired drilling terminus has been reached. Alternatively in the case where it is determined that the desired drilling terminus has not been reached, the drilling can be continued and based upon the results determined by the terminus decision module the drilling tool can be adjusted to shift the direction or other settings of that equipment in terms of the ongoing drilling of the well. Finally the method might also offer utility insofar as one of the terminus decision criteria which might be applied to the determination of whether or not a proper drilling terminus has been reached could be to figure out whether or not effectively the well was not economically feasible and whether drilling should just be stopped and moved to a new is drilling location.

The number of drilling sensors or sensory data streams captured to the drilling database in the method of the present invention could be any number. It may be the case that sufficient sensory data or information could be captured with the use of a single sensor or sensor package, or it may alternatively be the case that one or more data streams may require the use of one or more sensors. It will be understood that all such variations in the numbers of both the types of sensory data streams captured or the types of drilling data captured to the drilling database as well as to the number and type of drilling sensors which could be used in the method of the present invention are contemplated within the scope hereof.

The number of terminus decision criteria which could be used in the assessment of various locations within the well as drilling termini could also vary, as could the nature of such terminus decision criteria. Any number of different types of characteristics or categories of information could be used to determine, with respect to the needs or desires of a particular company or drilling outfit, whether or not their particular set of requirements for the reaching of an optimal drilling terminus had been reached, and all such variations in this factor of the method and system of the present invention are again contemplated within the scope hereof.

There are two particular types of terminus decision modules which are contemplated, and which go in hand with two different approaches to the selection or definition of the terminus decision criteria which might be applied to the drilling data stored within the drilling database. It is contemplated that the method of the present invention might first use terminus decision criteria which were fixed formulas which were preprogrammed and preset within the site computer or the terminus decision module software, and the comparison of location referenced drilling data from the drilling database to the terminus decision criteria which were these preset formulas would effectively comprise a is calculation of that formula based upon the location referenced drilling data in question and comparing the results of that formula to a predefined range of desirable results to assess whether or not a particular terminus decision criteria was met by a particular location within the well.

The second type of a terminus decision module which is contemplated, which goes in hand with a second approach to the set-up of terminus decision criteria but which also it is felt offers a maximum amount of flexibility as well as strength is to provide a terminus decision module which is effectively a fuzzy inference system or an “fuzzy logic” model, which based upon one or more terminus decision criteria can render recommendations regarding the propriety of particular specific locations within the well as desirable drilling termini based upon the comparison of all of the relevant terminus decision criteria applicable to a particular well to all of the drilling data stored within the drilling database with respect to each such specific location. While either a fixed formula method or a fuzzy logic or fuzzy inference system method to the terminus decision module is contemplated within the scope of the present invention, attendant changes or modifications which might be required to optimally implement either type of the system will be obvious to one skilled in the art and are contemplated to be within the scope of the claims outlined herein. The terminus decision criteria, in either a fixed formula or a fuzzy logic approach, could be stored within a rules database which was resident within or accessible to the site computer, which would allow for easy access for programming and upkeep.

Beyond the method of the present invention, the invention also deals with problems in the prior art by providing an intelligent system for use in locating a drilling terminus during the drilling of a subterranean well at a drilling site with a drilling tool. The intelligent system of the present invention has as its components firstly at least one drilling sensor for use within the well to capture sensory drilling data with respect to specific locations within the well in at least one drilling data stream, and a drilling database for storage of drilling data measured by the at least one drilling sensor within the well, said drilling data being stored with reference to the specific location within the well at which such drilling data was captured. The drilling database would be hosted on a computer located at the drilling site.

The next element of the intelligent system contemplated herein would be an interface between the at least one drilling sensor and the computer hosting the drilling database which would facilitate the capture of the at least one drilling data stream containing the sensory data with respect to locations within the well for storage to the drilling database.

Next there would be software operative on a site computer located at the drilling site which would comprise at least a terminus decision module which would assess the desirability of specific locations within the well as drilling termini based upon the comparison of the location reference to drilling data with respect to each such specific location contained within the drilling database to at least one terminus decision criteria.

Finally a user interface of some type would be operably connected to the site computer which would be capable of rendering the results of the assessment of or desirability of specific locations within the well which was conducted by the terminus selection module, for use in operation of the drilling tool. Using the intelligent system of the present invention, drilling of the well could be altered or stopped based upon the determination by the terminus decision module of the propriety of any particular specific location within the well as a drilling terminus.

The drilling database might be hosted either on the site computer, or on a separate network computer which was accessible to the site computer.

Again, the user interface contemplated within the system of the present invention might either comprise a human interface such as a display or the like, or might also include some type of a control interface directly to the drilling tool where the site computer could communicate to the drilling tool based upon calculations with respect to the data contained within the drilling database and could provide adjustments or corrections to the settings of the drilling tool automatically without human intervention, or at least automatically providing them to the drilling equipment for ratification or acceptance by the operator of that equipment.

Again the system of the present invention could be practiced in a number of different online or off-line embodiments. It is contemplated that the system of the present invention could be used in association with drilling sensors which could either be used within the well in the absence of the drilling tool, or within the well while the drilling tool was in operation.

Beyond the overall intelligent system of the present invention, there is also included within the scope of the present invention a site computer for use in locating a drilling terminus during the drilling of a subterranean well at a drilling site with a drilling tool, which site computer comprises a sensor interface for the connection of the site computer to at least one drilling sensor in the well, a drilling database accessible to the site computer and to which drilling data from at least one drilling sensor can be stored when received by the site computer via a sensor interface, said drilling data being stored in the drilling database along with location referencing coordinates related to the specific location within the well from which the drilling data was measured, as well as software comprising a terminus decision module which will assess the desirability of specific locations within the well as drilling termini based upon the comparison of the location referenced drilling data with respect to each such specific location contained within the drilling database to at least one terminus decision criteria. Finally, this site computer would also include a user output capable of rendering the results of the assessment of desirability of specific locations conducted by the terminus decision module to an external display or interface. The sensor interface on this site computer might comprise at least one communications port for connection to at least one drilling sensor. The user output from the site computer could be either an output such as a video port or the like for a human display interface, or could be some type of a digital or control interface or output at which could transmit instructions or information directly to a drilling tool via a drilling tool control interface so that the drilling tool could be operated automatically or with guidance from the site computer of the present invention when used in accordance with the method of the present invention.

In the site computer which is contemplated to be within the scope of the present invention the terminus decision criteria could be either fixed formulas or alternatively again a fuzzy inference system could be used. In the method, system or site computer of the present invention the terminus decision module could be configured to automatically select and apply only the appropriate terminus decision criteria based upon the nature and number of drilling sensors from which drilling sensory data is being stored to the drilling database. Put another way, the terminus decision module could automatically recognize which terminus decision criteria were relevant to be applied based upon the type of sensory data stored to the drilling database.

The site computer is contemplated to be capable of receiving drilling data via the sensor interface for recordal to the drilling database either during the operation of the terminus decision module or before the operation of the terminus decision module.

The invention also comprises a computer program which is operative to control a site computer for use in locating a drilling terminus during the drilling of a subterranean well in a drilling site with a drilling tool, the computer program effectively comprising a terminus decision module in accordance with the remainder of the invention outlined elsewhere herein. Specifically the terminus decision module would, when executed by a site computer, perform the steps of accessing from a drilling database accessible to the site computer location referenced sensory drilling data obtained from sensor measurements taken of at least one specific location within the well come being drilling data; assessing the desirability of those specific locations within the well as drilling termini based upon the comparison of the location referenced drilling data with respect each such specific location contained within the drilling database to at least one terminus decision criteria, and communicating the final results of that assessment of the desirability of these at least one specific locations within the well as drilling termini to a user interface of the site computer. The drilling of the well again is contemplated to be capably altered or stopped based upon the determination by this computer software terminus decision module of the propriety of any particular specific location within the well as a drilling terminus.

In addition to the computer software of the present invention as well as the overall system and business method disclosed herein, there is also disclosed an add-on sensory interface kit which could be used with an existing site computer. Effectively the add-on sensory interface unit would allow for the conversion of an existing site computer into a computer which could be used in accordance with the software and method of the remainder of the present invention. The sensory interface unit would be capable of connection to one or more logging tools or drilling sensors to be used down the well and capable of converting signals received from those sensors to data which could be communicated to and stored within the drilling database resident upon a computer operatively connected to the site computer, or alternatively if the drilling database were a resident within the site computer for storage directly therein.

The use of a dedicated computer with the software outlined herein, or alternatively the addition of the sensory interface unit such as is disclosed herein to an existing computer such of the existing computer could use a software the present invention are both contemplated within the scope era.

There is also disclosed herein a number of samples of the user interface which could be used in conjunction with a fuzzy inference system as the terminus decision module for analysis of data obtained from downhole drilling applications. The user interface in conjunction with the computer software of the present invention is also contemplated within the scope hereof

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a process flow diagram demonstrating one embodiment of the prior art analysis method which is used to analyze the propriety of a particular tool location in a drilling operation;

FIG. 2 is a process flow diagram demonstrating one embodiment of the process of the present invention, wherein data are locally analyzed at the drilling site in an offline fashion, during an operations shutdown;

FIG. 3 is a process flow diagram of an alternative embodiment of the process of the present invention wherein data are locally analyzed at the drilling site as the logging tools/sensors are operational and the drilling tool has been removed from the well;

FIG. 4 is a process flow diagram of an alternative embodiment of the process of the present invention wherein data are locally analyzed at the drilling site as the drilling tool is operational;

FIG. 5 is a diagram showing one embodiment of the intelligent system of the present invention, wherein the drilling database is a part of the system of the present invention;

FIG. 6 is a diagram showing an alternate embodiment of the intelligent system of FIG. 5, demonstrating the utility of the present invention in offshore or underwater drilling applications in addition to the inland drilling applications shown in FIG. 5;

FIG. 7 is a diagram showing an alternate embodiment of the intelligent system of the present invention, wherein the system is interfaced to a separate local source of sensory data in place of a proprietary drilling database;

FIG. 8 is a block diagram showing one embodiment of a computer system for use in practice of the intelligent system of the present invention;

FIG. 9 demonstrates the data flow in the operation of the computer system shown in FIG. 8;

FIG. 10 demonstrates the data flow in an alternate embodiment of the computer system of the present invention, where the system is integrated with the control of the drilling tool;

FIG. 11 is a block diagram of another embodiment of the computer system of the present invention, incorporating an external sensory input interface unit along with a pre-existing computer;

FIG. 12 is a block diagram showing one embodiment of the external sensory input interface unit of FIG. 10; and

FIGS. 13A through 13E are a series of sample embodiments of types of user feedback or displays that might be generated in accordance with the present invention.

### DETAILED DESCRIPTION OF THE ILLUSTRATED EMBODIMENTS

Prior Art:

Current methods of assessing and determining the proper drilling depth or tool locations in oil and gas drilling applications are resource-intensive. With a view to demonstrating the shortcomings of the conventional method, as well as framing the backdrop against which the present invention can be discussed, the following is a brief discussion of the general steps involved in present day oil drilling operations.

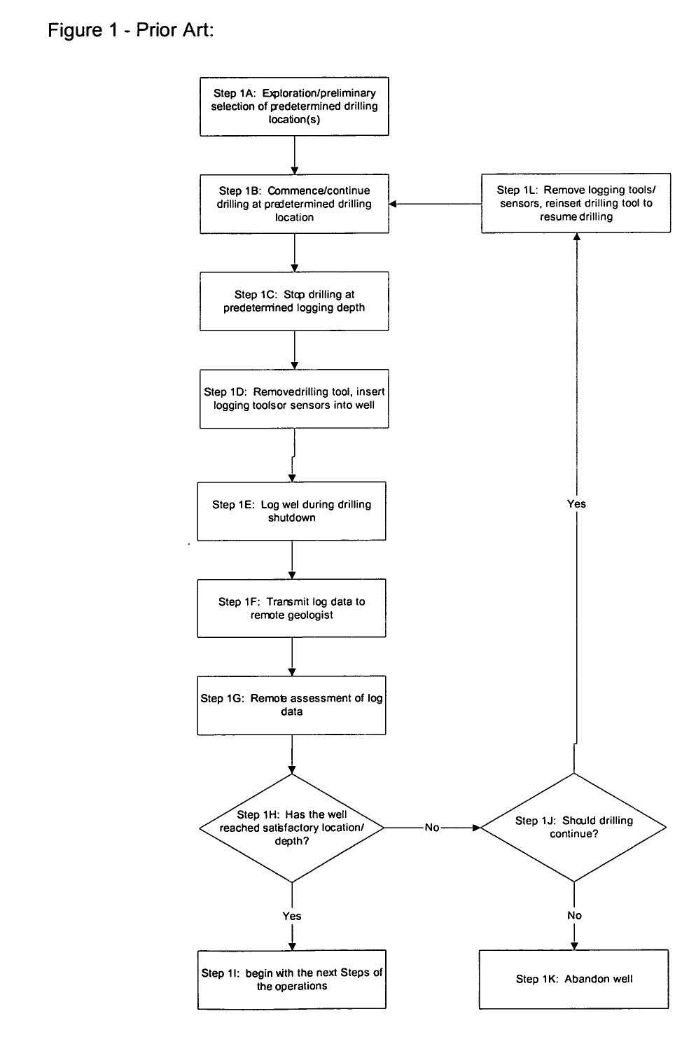

FIG. 1 is a process flow diagram of the prior art method of logging and analyzing sensory data for oil and gas drilling applications. The first step which is shown in the Figure at 1A is the exploration step. In the exploration step, a company, by various prior art means including seismic assessment or the like, will determine the spot or spots at which oil wells should be attempted to be drilled. These are referred to herein as predetermined drilling sites.

Shown at Step 1B in FIG. 1 is the actual commencement of drilling at one such predetermined drilling site. A drilling rig is set up at an subterranean site and the drilling tool is used to commence drilling into the earth. While the tools and demonstrative Figures shown herein show typical equipment used in inland drilling applications it is specifically contemplated that the system and method of the present invention could just as easily be practiced in offshore drilling applications and any attendant modifications to practice the invention in an offshore application would be obvious to one skilled in the art and as such are contemplated within the scope of the present invention.

Also, while the present application refers generically to using the system to reach an optimal ‘drilling terminus’ it will be understood that the drilling terminus, in a single-axis drilling application, would effectively be a desired depth. In a multiple axis drilling application such as a horizontal well or a well drilled using a maneuverable drilling tool, the drilling terminus to be reached may be a depth but may also include movement of the tool from the initial vertical axis, and that a drilling terminus which is just a drilling depth, or a multi-axis drilling terminus.

The drilling shown at Step 1B would continue until the well reaches a predetermined logging location, shown at Step 1C, which is a depth or location at which geologists have determined in advance that drilling should be stopped so that the state of the well can be assessed and the propriety of the drilling terminus or tool location can be assessed. For example, the geologists may believe from preliminary exploration results that there is an oil-bearing formation 1,200 feet below the surface—the first predetermined logging location might then be at 1,100 feet so that the well can be logged and data assessed to determine the proximity of the tool to an oil-bearing formation or to confirm the accuracy of the preliminary projections before the tool is pushed down into the formation. This is only one very simple example of the basis on which predetermined logging depths might be determined.

The next step in the prior art method is that the drilling tool is removed from the well and the logging tools or sensors inserted in the well in their place and lowered down the casing or down the well to perform the sensory analysis of the well as drilled to date. This is shown at Step 1D in FIG. 1.

Step 1E shown in FIG. 1 is the actual collection of the necessary sensory data for use by a geologist or experienced technician in assessing the propriety or suitability of a particular drilling tool location as a drilling terminus or for other purposes. Various types of data will be gathered and are sent to a geologist located offsite for review and analysis. The transmission of the necessary samples or data to the offsite geologist is shown at Step 1F in FIG. 1. Once the data or sample material is received by the geologist, it is analyzed to determine whether or not the well has been drilled to an appropriate depth or whether or not further depth needs to be drilled in order to reach an optimal location, or alternatively it may also be determined rather than deciding that the well has reached an optimum location, that the well is not going to reach an optimum location at all and that the tool should be pulled back, the hole capped and a new well drilled. The remote data analysis step is shown at Step 1G of FIG. 1.

The decision to continue with drilling to a new present depth for further logging and analysis is shown at Step 1H in FIG. 1—if it is decided that the well has reached a good depth for oil or gas extraction, or a desirable drilling terminus, the tool can be retracted or conventional casing and oil or gas extraction techniques commenced (shown at Step 1I). Alternatively if it is decided that a desirable drilling terminus has not been reached the second decision, shown at Step 1J, would be to decide if the well should be abandoned. If the well is determined to be fruitless it may be abandoned in favor of another predetermined drilling site (shown at Step 1K). If it is decided that the well is not yet optimal but should not be abandoned, effectively a loop back to the resumption of drilling to a new predetermined logging depth (Step 1L) where the remote data analysis can be repeated is shown in the remainder of FIG. 1. This step would also comprise the removal of the logging tools or sensors from the well and reinsertion of the drilling tool.

As outlined in general above, the shortcomings of this present method are numerous. The primary shortcoming which it is intended to address herein is the fact that sampling and analysis of the sensory data takes place offsite at a remote geology lab. Typically, a drilling company may only employ a small number of geologists compared to the number of wells they may be drilling at one time and, as such, it makes the most sense in that model for the geologists to work in a central site. However, as outlined above, the use of a model such as this where the data obtained from the drilling installation is transmitted to a remote site for analysis by a geologist is more costly, both in terms of the capital infrastructure required at the drilling site as well as in terms of the lost money or added costs associated with indeterminate or lengthened shutdown periods while the data is analyzed. For example, where the data is to be transmitted electronically to the geology site, it is necessary for the oil rig to be equipped with satellite or other means of communication by which electronic data can be transmitted or received back from the geology lab. In addition to the requirement for satellite transmission or receiving equipment at the drilling site, it is also necessary to have corresponding communications infrastructure in place in the central geology lab. Alternatively, in a situation where the logging data were not to be transmitted electronically, but rather physically delivered to a centralized geology site, the time and cost associated with the transport of that information also renders the present day method impractical.

The second major cost associated with the present day method of analyzing oil well drilling activity is the time and cost associated with the use of an actual geologist in the assessment of the propriety of a particular drilling terminus. Not only is it costly to employ a geologist, and it makes sense in most cases to employ them at a remote site given the number of wells they would be responsible for monitoring at all kinds of different scattered sites, but as long as the data are being analyzed by one or more geologists either onsite or at a remote site the shutdown periods at the rig are longer and more costly than if some more automated method of monitoring and/or reviewing the logging data from the well could be come up with. For example, it may be the case that when the sample data from a particular well drilling site is transmitted to the geology center they are already working on data for numerous other sites and, as such, the shutdown could take anywhere from a shorter period of a couple of hours through to a number of days. During this entire time, the rig sits idle with labor costs continuing to run, and the opportunity cost of moving the rig on to a new site sooner are also continuing to rise.

By drilling to predetermined logging depths, the drillers can never reach with a specific degree of precision the exact location of the oil or gas in question, based solely on the use of exploration data obtained in advance of the drilling of a hole. For example, drilling down to predetermined logging depths may cause undershoots or overshoots. An undershoot would be known in the industry as when the drilling is done to a predetermined depth which is above where the oil is located. On the contrary, an overshoot would be a situation in which the drilling is continued either into or through the oil deposit to the point that the oil deposit is left behind as the hole continues downward. Neither of these results is optimal, obviously, and results in imprecise ability to drill to the right location.

General Method Overview:

There is disclosed a method for the assessment of the propriety of a drilling terminus or drilling site in a subterranean drilling application. The method effectively comprises capturing one or more sensory data streams from a well being drilled, and applying a computer implemented formula or fuzzy inference system to those data to provide to the operator of the drilling equipment recommendations and instructions as to whether or not the drilling tool has reached an appropriate drilling terminus at which the well could be terminated and/or alternatively if drilling should be continued in the same or another direction. For companies that use conventional well logging tools the system would help them to analyze the data in the oil fields, but it will not necessarily be in real time. Conventional well logging tools are the ones that cannot conduct the logging process while drilling is being done. In this case, oil companies drill to a predetermined depth, take the drilling tools out of the well and then introduce the drilling sensors or other tools for the logging process. This means that the analysis of the data has to wait until the logging tools are reintroduced into the oil well.

Once the sensory data were captured from the sensors, they could be analyzed by the system of the present invention to determine the propriety of various locations within the well as drilled so far as a drilling terminus and drilling operations could either then be resumed based on feedback or instructions provided by the intelligent system of the present invention or alternatively drilling could be terminated for either positive or negative economic reasons, i.e. that either the appropriate depth had been reached from which to extract oil or gas from the well, or alternatively it had been determined either by the system itself or the system had advised the operator of the drilling equipment, who confirmed the decision, that the abandonment of the well was an appropriate option for consideration.

In an offline embodiment, the sensory data streams described herein would be captured in a drilling database accessible to the site computer in which the software of the present invention is operated, during a drilling shutdown at the drilling site. In another embodiment, the method of the present invention could be used in a system where the drilling tool was removed from the well to insert the drilling sensors or tools, while the well was being logged (i.e. rather than during a drilling/logging shutdown). The sensory data stream or streams would be captured in a drilling database accessible to the site computer in which the software of the present invention is resident during a drilling shutdown at the drilling site. Once the data were captured from the sensors, they could be analyzed in real time by the system of the present invention.

Some companies have been exploring new technologies that allow them to capture drilling sensory data while they are drilling. These companies have developed drilling sensors that are able to resist the tough conditions present during the drilling process. This means that with the intelligent system of the present invention these oil companies would be able to analyze the drilling sensory data in real time while the drilling process is being done. In this scenario oil companies would not need to drill to predetermined depths to take sensor readings, minimizing undershoots or overshoots.

In one online embodiment of the method of the present invention, the sensory data streams described herein could be captured on an ongoing basis from sensors present in the well as drilling operations continue. The sensory data is fed back to a drilling database which is again accessible to the computer involved in the execution of the terminus decision module software component and the remainder of the method of the present invention. When the terminus decision module software of the method of the present invention determines that a desirable drilling terminus had been reached, drilling operations could be ceased. Alternatively, if the terminus decision module determined that a drilling terminus had not yet been reached from which extraction was optimal and/or that the situation did not at this point yet warrant abandonment of the well, the terminus decision module, in the next step of the method, could display to the user of the system the feedback used to continue drilling which might either include simply an indication that drilling should continue or alternatively may also include further information regarding either the analysis applied to the sensory data and/or alternatively the directions regarding realignment or movement of the drilling tool in multiple axis drilling applications.

Effectively then it is contemplated that there are three different circumstances or is workflows in which the method of the present invention could be employed. The first of these would be to analyze the sensor data during a complete equipment shutdown. The second circumstance would be to analyze the sensory data during the logging of a well (i.e. while the drilling tool is removed and logging or sensor tools are inserted into and being moved down the well). Finally, in cases where logging or sensing can be done while drilling, the present invention could be practiced during drilling.

The apparatus and method of the present invention could be useful in a number of different applications. Firstly, while the applications in which the present invention can be used are referred to herein as “subterranean” drilling applications, it will be understood that this is intended to encompass both onshore and offshore drilling. Specifically, there would be no major changes to the method or system of the present invention which would be required in order to practice the method in an offshore well as compared to an onshore or inland well, and it is contemplated that the use of an onsite and local logging of data analysis method such as is proposed herein in either an offshore or an inland application is contemplated within the scope of the present invention.

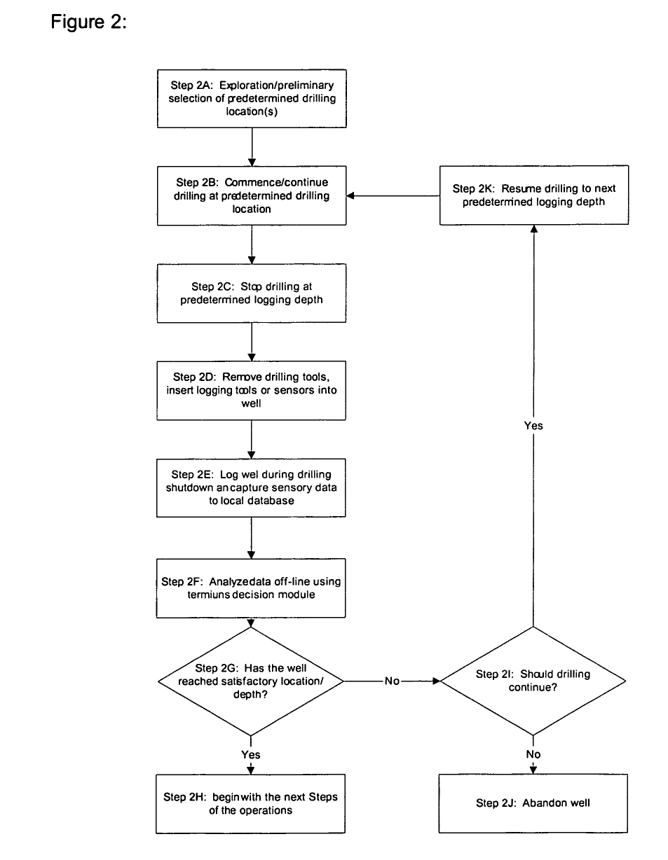

FIGS. 2, 3 and 4 are provided to demonstrate the general flow of the three main contemplated embodiments of the present invention, from which variants to accomplish various specific objectives for individual wells can be contemplated and will be understood to be contemplated within the scope of the present invention.

FIG. 2 is a process flow diagram showing the method of local automatic intelligent assessment of well log data in an offline fashion—i.e. a drilling shutdown could still take place while the data were assessed. In terms of commencing drilling of a well in accordance with the method of the present invention, the preparatory steps would be the same as those conducted at the present time for other conventional drilling. Shown at Step 2A is the exploration step, wherein one or more predetermined drilling sites would be selected based upon exploratory geological work. That type of exploration work is often done using equipment and technology such as seismology, magnetometers or gravity meters, as outlined in further detail above. These are just a few of the types of exploration techniques which can be used to determine the initial point at which it might be desired to try to drill a well. The uncertainty associated with the early exploration results, however, forces geologists to confirm the results regarding location of the oil or gas which is sought during subsequent phases of the oil drilling process. The initial stages of a drilling operation, including exploration and location of the drilling locations to be used, will be understood by one skilled in the art to not be contemplated within the scope of the present invention in a limiting scope. Those steps are shown within the Figures of this patent to give a full understanding of how the system of the present invention might integrate with the well drilling process, but it will be understood by one skilled in the art upon consideration of the remainder of this specification that the method of the present invention is specifically directed towards the use of the terminus decision module software combined with a local instrumentation package and a local site computer to advise the operator of a drilling tool upon the propriety of a particular point reached in the drilling of the well as a drilling terminus, or alternatively to directly control the drilling tool. As such it will be understood that the demonstration of the selection of predetermined drilling locations, while considered useful by the inventors for the sake of demonstration of the technical problem addressed by the present invention, is not an essential element to be included within the claims of the present patent application.

Once a predetermined drilling site is decided or selected, the drilling rig can be set up and drilling can be commenced. Drilling commencement is shown at Step 2B in FIG. 2. The drilling rig typically would first drill down to a first logging location which was previously selected based on the earlier exploration data obtained. In this particular embodiment of the method of the present invention, this prior art method of drilling to a particular predetermined logging location at which point in time the logging sensor or tools can be inserted into the well is accommodated.

Once a predetermined logging location is reached, shown at Step 2C, the removal of the drilling tools and insertion of logging tools or sensors into the well is shown in FIG. 2D. Next, sensory data are captured with respect to the well or hole as drilled so far. This may consist of various types of drilling sensors or sampling taking place within the well, at or near the drilling tool. Many conventional or prior art sensing or logging methods might be used, modified only to the extent that the readouts or data from those sensors will be captured locally at the drilling site to a drilling database for use by the intelligent system of the present invention. Capture of drilling sensor data to a drilling database is shown at Step 2E in FIG. 2.

In addition to the actual sensory data from the drilling sensors within the well, the drilling data contained within or stored to the drilling database could include reference or indication of the location within the well at which each such sensory reading was captured. In a circumstance where the method of the present invention was being used to effectively “sample” readings at various locations within the well, rather than to simply assess the drilling data with respect to particular location in the well by lowering the drilling sensors to that location and taking readings from their upon which assessment can be taken on the surface, it will be necessary for the drilling database to in some fashion know where the location is within the well at which each sensor reading was taken so that sensor readings from various sensory data streams can all be compared in respect of the same location within the well, as well as so that the sampling or assessment of the sensory data with respect to multiple locations within the well as drilled so far can be conducted at the same time or in serial fashion.

The intelligent system of the present invention is a computer hardware and software system capable of analyzing the sensory data captured in the drilling database to provide drilling feedback or recommendations to the rig operators. Specifically it is contemplated that a terminus decision module consisting of some type of fuzzy inference or ‘fuzzy logic’ system or computer based formula might be used to determine an optimal drilling terminus or the presence or absence of recoverable oil or gas at a particular location in a well based on the analysis or blending or combination of the various sensory data stored within the drilling database with respect to that particular location. Analysis of the sensory data captured to the drilling database up to the predetermined logging location in the well by the intelligent system, and more specifically by the terminus decision module in conjunction with the remainder of the components of the system, in the method shown in FIG. 2 is shown at Step 2F.

Whether the terminus decision module employs a fuzzy inference or a computer based formula system in analysis of the sensory data contained within the drilling database, the terminus decision module at Step 2F will determine if the well has been drilled to a satisfactory location or depth for oil or gas extraction or, in reference to the terminology used in the remainder here of, whether or not a satisfactory or desirable drilling terminus has been reached. If it is determined by the intelligent system on the basis of the sensory data contained within the drilling database that an optimal drilling terminus has been reached—either at the terminus of the well as it stands, at the tool face, or at a point up the well (i.e. if the optimal location has been overshot)—then the operator of the rig can be notified by the intelligent system through a conventional user interface and the regular process of tool recovery/casing/extraction can begin.

Alternatively, if the terminus decision module of the intelligent system determines that an optimal drilling terminus has not yet been reached, and if the terminus decision module determines that the well is not a candidate for abandonment—i.e. so long as the system determines that the well should not be abandoned or the operator decides not to abandon the well based on information or feedback from the intelligent system—then drilling could be recommenced to a next predetermined logging location, where new drilling sensory readings could be taken and a new assessment repeated in terms of assessing the feasibility of the well and whether or not an optimal drilling terminus has yet been is reached. This is shown at Step 2J, looping back to another drilling stoppage at 2C. If the terminus decision module determined, or the operator decided, based on the data obtained from the well, that the well should be abandoned (shown at 2I) appropriate shutdown steps could be taken and the rig moved to a new drilling site.

By using a computerized intelligent system in accordance with the present invention which is capable of collecting and analyzing the drilling data with respect to a well from the drilling database as outlined herein with a terminus decision module, the various types of sensory data can be accumulated and assessed onsite and it can be decided, in accordance with a predetermined matrix or formula within the system, whether or not a desirable drilling terminus has been reached, or alternatively whether drilling needs to go deeper or further, or if a particular location is just not good for further drilling in which case the drilling can be abandoned and a new site started.

By assessing the drilling data captured by a drilling sensor and stored to a sensory database for the well onsite rather than at a remote site, the need for satellite or other communications equipment at the drilling rig for this purpose is eliminated. This can result in a significant cost reduction. As well, by assessing the data locally rather than remotely it is likely that shutdown times between drilling sessions in instances where the method outlined in FIG. 2 is practiced can be minimized. The second option, however, which is submitted will enhance completion times and profitability in drilling operations, beyond simply analyzing the data locally rather than remotely as in the embodiment shown in FIG. 2, is the addition of an online aspect to the system wherein if the intelligent system of the present invention incorporates software and hardware which is capable of capturing and analyzing various drilling sensor data captured in the drilling database with respect to the well in automated fashion during drilling, then the need for drilling shutdowns could even be avoided and the system could monitor data and provide the necessary corrections or adjustments to the drilling process as might be required on a ongoing and online basis.

The embodiment of FIG. 2 demonstrates both the preparatory steps to the selection of a drilling site, through to the location of the drilling tool and commencement of drilling, as well as the following steps after the determination that an appropriate drilling terminus has been reached—namely the recovery of the drilling tool and either the closure or commercial exploitation of the well. The primary aspects of the method of the present invention however relate to the sampling of data with respect to the well as it is drilled and the assessment of that data on an ongoing basis against a predetermined or fuzzy inference model to determine based on the data captured to a drilling database whether or not an appropriate drilling terminus had been reached. Insofar as the sampling and assessment of the sensory data with respect to the well as it is drilled are the primary aspects of the invention it will be understood that the preparatory steps, as well as the following steps upon determination of the reaching of a good drilling terminus are dependent upon these preparatory steps and on that basis or not contemplated to be within the broadest scope of the claimed invention.

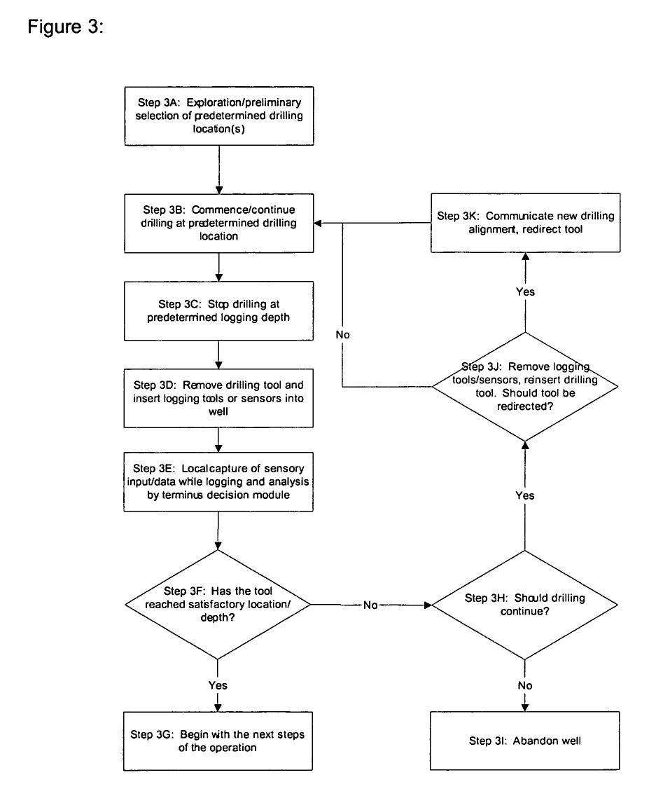

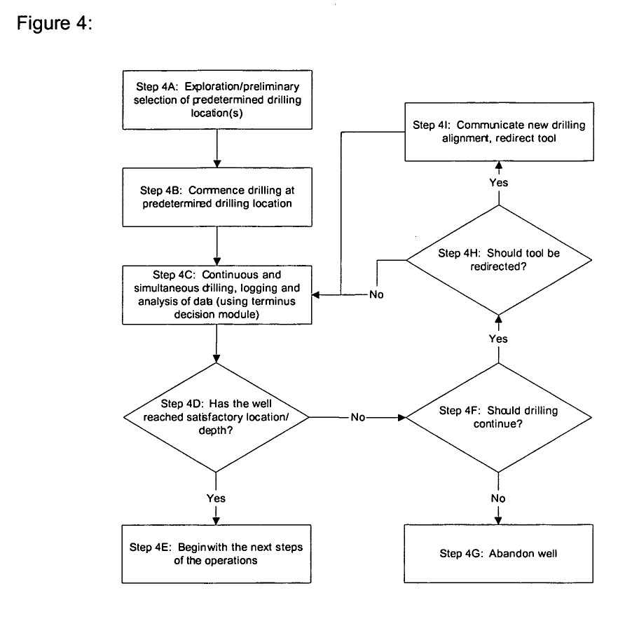

Referring next to FIG. 3, there is shown a process flow diagram of an alternate embodiment of the present invention which is effectively a method by which the drilling sensor data captured from within a drilled well can be captured to a drilling database and analyzed in real time by an intelligent system to advise the operator of the drilling rig as to the appropriate action to be taken with respect to movement of the drilling tool, or at such point in time as an appropriate drilling terminus is reached. The method of FIG. 3 as outlined above can operate in an effectively “online” fashion whereby it would operate during the logging of the well and no logging shutdown would be contemplated within the scope of the method disclosed in FIG. 3. This is different from the method which will next be disclosed in FIG. 4, which contemplates actual realtime analysis of drilling sensory data from within the well during drilling, where drilling sensors (7) which can be used while drilling is taking place are contemplated to be used.

Where the application herein refers to “logging” of the well or “logging tools”, logging is a term of art within the drilling industry which refers to the sensory assessment and capture of sensory data with respect to the characteristics of the well. The logging of a well effectively typically comprises a lowering one or more logging tools or sensor packages down the well which can as they are lowered to take sensor readings of various characteristics of the geology or of the well. For the sake of the contents of this application in the understanding of the present invention, where we refer herein to “drilling sensors” or the capture of drilling sensory data with respect to a well, the translation of this into the lexicon of “logging” would result in the equivalent reading of “drilling sensors” to also mean “logging tools or sensors” as those might be understood by one skilled in the art.

The first number of steps of the method shown in FIG. 3 are similar to that of the method shown in FIG. 2. Shown at Steps 3A and 3B are the commencement of drilling at a particular predetermined drilling site.

Once a particular predetermined logging location was reached during the drilling of the well, the drilling tool would be removed from the well and the drilling sensors (7) would be inserted into the well and provide the necessary sensory data with respect to the well as drilled to date. This is shown at Step 3C in FIG. 3. In terms of the number of drilling sensors which could be used in any embodiment of the method of the present invention it will be understood that the minimum number of sensors or sensor packages which might be used would be one, but there may in fact be more than one sensor or sensor package used within the well to capture one or more types of sensory data with respect to the well and that any number of drilling sensors or combines sensor packages which might desirably be used by someone practicing this invention is contemplated within the scope hereof.

Shown next at Step 3D in FIG. 3 is the local capture of the sensory input or sensory data from the sensors or tools lowered down the well for that purpose to a drilling database. In the practice of the method of the present invention, the analysis of the logging data captured to the drilling database could take place as the data were being recorded to the database. Specifically, on an ongoing basis as the data were being captured as shown in Step 3B, the terminus decision module could analyze the sensory data being captured in real time and provide feedback or indications to the operator in an ongoing loop, and it is contemplated then that effectively as additional sensory data were captured that they would also be similarly analyzed from the drilling database, and ongoing feedback prepared and displayed or made accessible to the operator in some fashion. The sensory data which was stored to the drilling database would in some fashion need to reference the location within the well from which that particular piece of data was captured. This is necessary both where more than one data stream or more than one sensor was used in order to be able to compare all of the sensory data from a similar location within the well at the same time, and also to be able to conduct an ongoing assessment of the sensory data from the drilling database where a “sampling” effect was created by the conduct of a continuous assessment loop of the type outlined herein.

Shown next at Step 3E in FIG. 3 is a decision by the terminus decision module which would be a part of the ongoing analysis of the data in real time from the drilling database as it is captured, namely whether or not the logging tool has reached a satisfactory location or depth within the well, which would imply that the drilling tool has also reached a similar location and that location may be a satisfactory drilling terminus for the well.

There is shown at Step 3F in FIG. 3 a determination in that decision block that a location from which profitable oil or gas recovery could be made had been reached i.e. a beneficial or satisfactory drilling terminus had been reached. Alternatively, if the Step 3F decision block is determined in a negative fashion (i.e. that the particular location to which a particular set of sensory data corresponds is not a satisfactory drilling terminus for profitable recovery) another decision block, which is shown at Step 3G, is to determine whether or not drilling should continue. If it is determined by the terminus decision module and/or the operator that drilling should not continue and that a well should be abandoned since there would not appear to be any zone for profitable recovery, that is shown at Step 3H in FIG. 3.

Shown at Step 3I in FIG. 3 is another decision block which pertains to the determination of whether or not logging or the capture of sensory data from the sensors down the well should continue, or alternatively whether drilling should be recommenced. If it were determined that logging should continue and the drilling sensor or sensors should be continued to be lowered down the well as drilled, this is shown as the “yes” leg of the decision coming off Step 3I in FIG. 3, effectively completing the analysis loop back to Step 3D which would mean that logging tools or sensors would continue to be lowered down the well or would continue to be used to capture additional data for additional analysis by the system of the present invention.

Alternatively, if it were determined at Step 3I in the decision process shown in FIG. 3 that logging should not continue and that drilling should be resumed, then the “no” leg of the decision block shown at Step 3I shows that the operator could be advised by the system or in accordance with the business method of the present invention in some fashion the drilling tool could be reinserted into the well. The drilling tool being reinserted into the well is shown at Step 3J in FIG. 3. The system could also provide analysis or advice to the operator as to whether or not any adjustments or realignment should be made to the drilling tool and this is shown also as a part of Step 3J. Effectively, Step 3J in FIG. 3 shows the reinsertion of the drilling tool as well as a determination of whether or not the tool should be redirected. Shown as the “yes” block is of the Step 3J decision is the communication of new drilling alignment or tool redirection, shown at Step 3K. Alternatively, if it were determined at Step 3J after reinserting the drilling tool that no drilling realignment or redirection were required then simply following the “no” leg of that decision block back to Step 3B, it can be seen that the drilling tool upon its reinsertion would recommence or continue drilling to another predetermined drilling terminus, at which point in time the method of FIG. 3 could be repeated, that is to say that the drilling tool could again be removed, the sensors placed in the well and the sensing or logging process recommenced.

Referring next to FIG. 4, there is shown a process flow diagram of an alternate embodiment of the method of the present invention which is effectively a method by which the drilling sensor data captured from within a drilled well can be captured to a drilling database and analyzed in real time by the intelligent system to advise the operators of the drilling tool as to the appropriate action to be taken with respect movement of the tool, or at such point in time as an appropriate drilling terminus is reached, the method of FIG. 4 as outlined would operate in effectively an “online” fashion whereby no drilling shutdowns are contemplated within the scope of the method disclosed therein.

The first number of steps of the method shown in FIG. 4 are similar to that of the method shown in FIG. 2. For example, preliminary selection of one or more predetermined drilling locations is made based on initial exploration work, shown at Step 4A. Shown at 4B is the commencement of drilling at a particular predetermined drilling location. It is contemplated that the drilling apparatus used in the practice of the method of FIG. 4 would be properly instrumented such that the necessary or required drilling sensor data which the particular driller felt was necessary to properly assess the propriety or nature of a particular drilling terminus would all be capable of being captured to a drilling database during the drilling of the well by the addition of the necessary drilling sensors or instrumentation to the drilling equipment used in the drilling shown at Step 4B. The actual capture of sensory data to a drilling database for real time analysis by the terminus decision module of the present invention is shown at Step 4C. as outlined elsewhere herein the drilling database in addition to containing the actual sensory information or readings captured within the well might also reference the specific locations at which particular pieces of sensory data contained within the drilling database were captured within the well. In this type of a embodiment of the method of the present invention however, where the analysis of the sensory data was being conducted on a real-time basis during the drilling of the well, it may not be so necessary to have a lot of additional location reference or coordinates stored to the drilling database provided that the sensor readings themselves were being taken at a location in the well close enough to the drilling tool that effectively by conducting the data analysis step of the method of the present invention on an ongoing basis and in a rapid enough fashion, the drilling tool would effectively still be at the location from which the sensory data in question were captured when the analysis of that particular data was completed by the intelligent system of the present invention. In that particular case the “location reference” of the specific sensory data being analyzed by the intelligent system of the present invention may simply be the present location of the drilling tool, or some particular precalculated offset location in the circumstance where the sensor or sensors were located in the well in a fixed or already known location ahead of or behind the drilling tool.

By using a drilling apparatus which is instrumented for the online capture of drilling sensor data with respect to the well, it is possible to have the intelligent system of the present invention analyze in real time the drilling sensor data as it is captured to the drilling database and while drilling operations continue. This would allow for the intelligent system to assess the nature and location of the well and the present terminus of the well below the surface without requiring drilling shutdowns. This could have numerous benefits, particularly in the instances where multi-axis drilling is to be carried out, since if drilling were continuing and the data were being captured and assessed in an online fashion, ongoing adjustments to the direction and alignment of the drilling tool could be made as necessary.

In any event, Step 4D in FIG. 4 shows a decision block which effectively represents the analysis to be conducted by the intelligent system of the present invention on an ongoing basis of the sensory data being captured to the drilling database. Effectively, the decision which is shown at Step 4D is a decision as to whether or not an appropriate and satisfactory drilling terminus has been reached, or effectively if there is profitable oil and gas at the particular location in question, on the basis of which drilling of the particular well could be ceased. If an appropriate depth has been reached, either at the drilling terminus or at some point which is determined to exist back up the hole from the drilling tool (again, in the situation effectively of an overshoot), drilling activity can be ceased and the conventional recovery of the drilling tool and extraction of oil or gas from the well can be commenced, as shown at Step 4E. Alternatively, if it is determined that the tool has not reached a satisfactory location from which oil or gas can be recovered, one would look at the second leg of the decision block shown at Step 4D in FIG. 4. Basically, if the appropriate location has not been reached, the next decision which could be undertaken by the intelligent system of the present invention using the terminus decision module (again in accordance with whatever fuzzy inference system or otherwise programmed computer-implemented formula as an analysis tool is contained therein for the weighting or analysis of this sensor data capture to the drilling database) is that of whether or not drilling should continue. This is shown at Step 4F in FIG. 4.

If it is determined, for example, that it is a “dry hole” or that the well is otherwise not economically feasible or the like and that it should be abandoned, Step 4G in FIG. 4 simply indicates how the equipment could be extracted and the well abandoned. Alternatively, however, the second leg of that decision shown at Step 4F in FIG. 4 is that if the determination is made that drilling should continue, then the operator of the rig could be advised in an ongoing fashion by some type of human interface or alternatively otherwise the drilling of the well could continue with the capture of sensory data and analysis thereof by the intelligent system shown in Steps 4C through 4F and 4J continuing in a loop fashion until either an appropriate drilling terminus was reached or alternatively a determination was made to cease drilling and abandon the well.

Where we refer to the “drilling terminus” within this document, what is intended or referred to is a particular subterranean location in the drilling of the well. In the drilling of a well in a single axis i.e. vertical, a particular drilling location below the surface would effectively be at a depth only and so a particular drilling terminus would be a particular drilling depth. In a drilling application where multiple axes of movement were capable or possible with the drilling tool however, or in a horizontal drilling application, a particular drilling terminus may be at coordinates other than simply a depth below the surface and it will be understood that in any event the use of the term “drilling terminus” is used to refer to any subterranean location which is the end of a well as drilled. A “satisfactory” or desirable drilling terminus might be the termination of a particular well at which point it was determined that there was economically feasible oil or gas to be recovered, but there will also be circumstances in which a well is capped or abandoned and the bottom and/or extreme end of that well would still constitute a drilling terminus as well.

Also shown at Steps 4H and 4I in FIG. 4 is a further extension of the methodology of the present invention. Effectively, it is contemplated that using the intelligent system of the present invention in direct communication with the drilling equipment itself, or by at the very least provision of additional user interface information to an operator, it can be contemplated that the intelligent system could, beyond advising of the propriety of a particular drilling terminus which has been reached, also provide to the operator or directly to the instrumentation of the drilling rig specific instructions or feedback regarding any adjustments which might be made to optimize the drilling process with respect to the well. It is particularly contemplated that in the case of horizontal or multi-axis drilling, it may be possible using a fuzzy inference system such as is contemplated within the scope of the present invention as the terminus decision module to predict the proper alignment of a tool to reach on a multiple axis basis a desired location or drilling terminus.

As shown at Step 4H in FIG. 4, if it were determined by the intelligent system that the drilling tool should be redirected or realigned in some fashion before continuing drilling, that new drilling alignment could be communicated either directly to the drilling equipment or to the operators of the drilling equipment and the tool could be redirected as the drilling is continued at Step 4J and looping back again to the continued capture and analysis of sensory data from the well as is shown in the remainder of FIG. 4. It is contemplated that this additional aspect of the invention could add further utility in horizontal and multi-axis drilling applications.

The general processes shown in FIGS. 2, 3 and 4 demonstrate only certain embodiments of the decision process contemplated within the scope of the present invention. For example, the particular characterization of the decisions being made by the terminus decision module of the present invention in advising the operator or carrying out actions based on the sensory data captured to the drilling database may be characterized in any number of different ways and all of which are contemplated within the scope of the present invention. That is to say that the rules or the formulas applied to the data captured to the drilling database by the remainder of the system of the present invention could incorporate significant additional steps or significant additional detail or minutia in a decision making process or additional decisions or decision trees could be added to the general data flow and process flow shown in the figures of the present document, and all such changes which would still not depart from the general concept of the use of an onsite local intelligent system to provide either in a realtime or rapid fashion, without communication to an offsite geologist, advice to an operator of a drilling unit whether or not they should conduct further drilling or sensing with respect to a well are all contemplated within the scope of the present invention.

System Components:

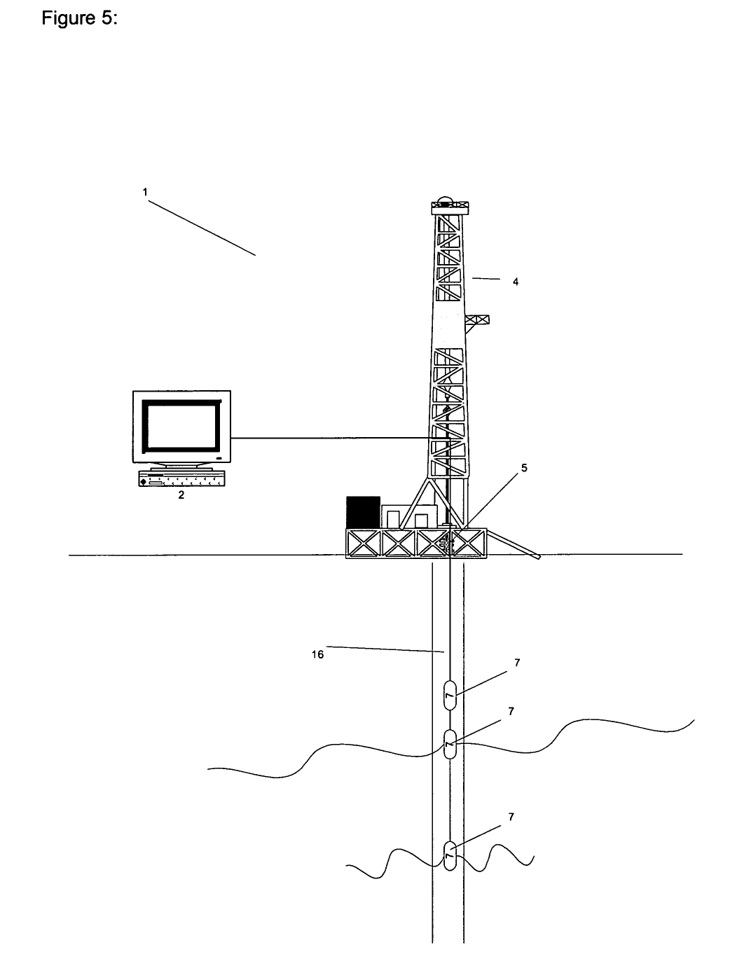

To review now briefly the major components of the system of the present invention which are used to practice the method disclosed herein, we refer to FIGS. 5, 6 and 7. FIG. 5 demonstrates one embodiment of the system of the present invention implemented in a vertical drilling application. There is shown the intelligent system (1) of the present invention, which includes a drilling tool (5) and its related equipment (4), The well itself which is being drilled is shown at (16).

There are also included one or more logging instruments or drilling sensors (7) which are capable of capturing different information with respect to the well itself or the characteristics of the surrounding geology of the well (16) as drilled. In this particular case, three sensors (7) are shown. It is contemplated that the system (1) of the present invention could either be used in an offline fashion, wherein the sensors (7) would be potentially lowered down the well (16) for the purpose of measuring or assessing the various formations or characteristics associated with the well during a drilling shutdown, or alternatively the system (1) of the present invention could be used in an online fashion, wherein the drilling sensors (7) could be attached to the drill stem or extended down the well (16) in some other fashion during drilling operations, continuously feeding data back to the remainder of the system (1). The use of the system (1) of the present invention in either such an offline or online fashion is contemplated within the scope of the present invention.

The drilling tool (5) itself is shown retracted from the well (16) in this case—presumably this shows a sensor (7) array being used down the shaft during a drilling shutdown, but it will be understood that showing the tool (5) in a withdrawn position from the well (16) while the sensors (7) are deployed is not intended to limit the scope of the present disclosure and invention to use in this fashion—it is specifically contemplated that the system (1) of the present invention could be used with the tool (5) in place in the well shaft (16), either while drilling is taking place or while drilling is stopped, and any necessary design modifications to the sensors or their system of deployment down the well to accomplish this objective are contemplated within the scope of the present invention.

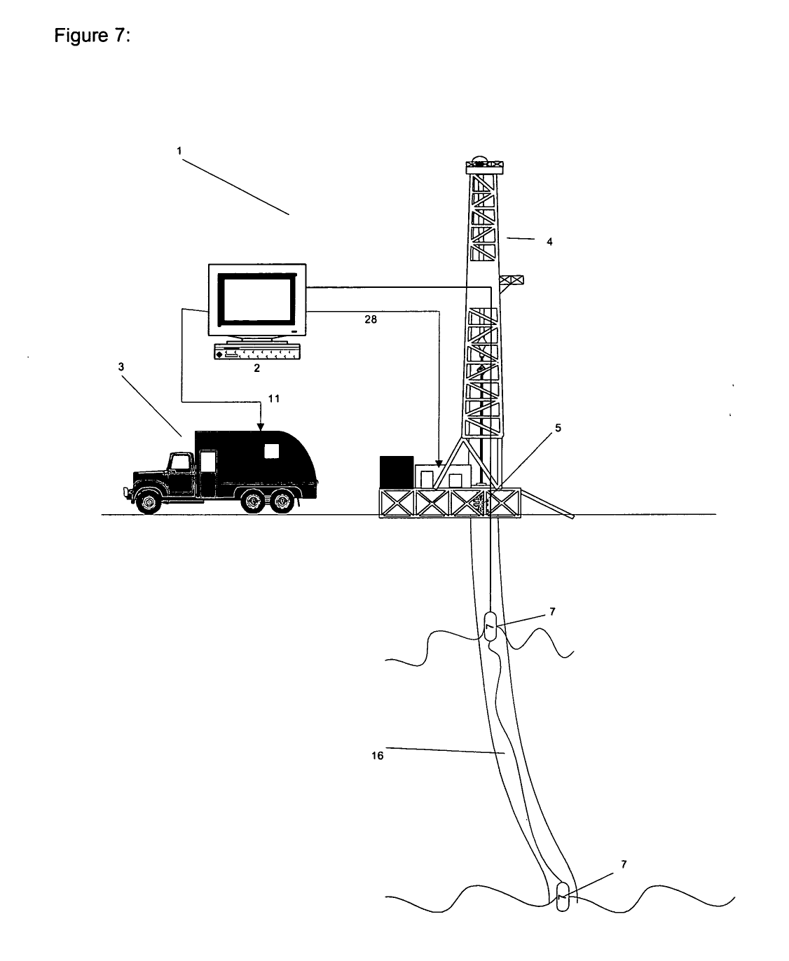

In addition to the drilling tool (5) itself and the associated sensors (7) which are capable of sensing and capturing data with respect to the well being drilled, the sensors (7) would be interfaced back to a site computer (2) at the surface, which site computer (2) would contain a drilling database (6) capable of capturing the different sensory data streams from the sensors (7). The specifics of the site computer (2) and the drilling database (6), along with the remaining software components necessary for the practice of the present invention, are disclosed in further detail elsewhere herein. On this first cursory level, the site computer (2) contains the drilling database (6) as well as a terminus decision module (10) which is a software component executable on and thereby capable of analyzing in real time the contents of the drilling database (6), which are effectively the sensor data readings from the drilling sensors (7) down the well (16), and providing recommendations or feedback to the operators of the drilling tool (5) as to either the termination of a well, or alternative if used in a multi-axis drilling application such as is shown in FIG. 7, it might also provide recommendations or instructions to the operator of the equipment in terms of adjusting the positioning or alignment of the drilling tool (5).

As outlined elsewhere herein, feedback would be provided to the operators of the equipment via a user interface which might be a human interface such as a computer monitor or the like as is shown in FIG. 5. In other embodiments of the invention, such as that shown in FIG. 7, it is also contemplated that the user interface might, rather than being a computer monitor or the like for human monitoring and intervention, be a direct mechanical or control interface between the site computer (2) and the drilling tool (5) which could basically automatically transmit corrections or drilling instructions to the drilling equipment and the drilling tool (5) based on the ongoing assessment of the contents of the drilling database (6) by the terminus decision module (10).

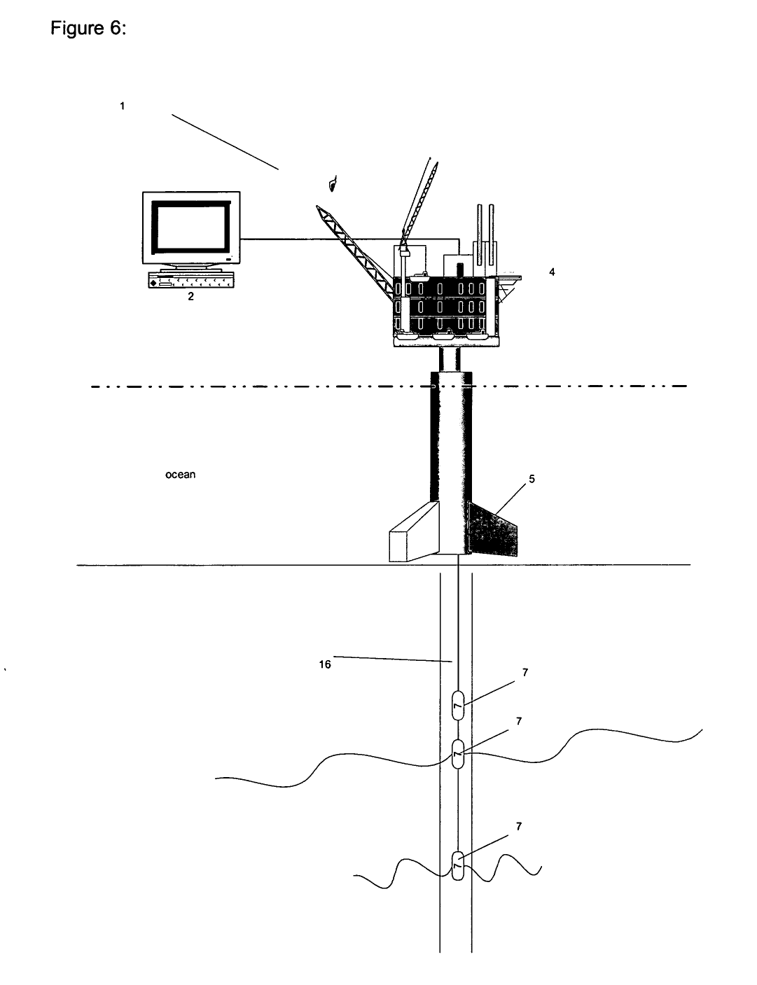

FIG. 6 demonstrates another embodiment of the system of the present invention implemented in an offshore vertical drilling application, simply to briefly demonstrate the utility of the invention in offshore applications. There is shown the intelligent system (1) of the present invention, which includes a drilling tool (5) and its related equipment (4). The well itself which is being drilled is shown at (16). In this case the drilling equipment (4) which is shown is a single-column offshore drilling platform. There are also included one or more logging instruments or drilling sensors (7) which are capable of capturing different information with respect to the well itself or the characteristics of the surrounding geology of the well (16) as drilled. In this particular case, three sensors (7) are shown.

In addition to the drilling tool (5) itself and the associated drilling sensors (7) which are capable of sensing and capturing data with respect to the well being drilled, the drilling sensors (7) would be interfaced back to a site computer (2) at the surface, which site computer (2) would contain a drilling database (6) capable of capturing the different sensory data streams from the sensors (7), and a terminus decision module (10) resident and executed thereon.

FIG. 7 shows an alternative embodiment of the system (1) of the present invention which is effectively modified by showing an interface between the site computer (2) and the drilling tool (5), for use in a multiple axis drilling application. Specifically, the system (1) again includes a drilling tool (5) and a number of sensors (7) attached thereto. In this particular Figure, two sensors (7) are shown. Again, it will be understood that any number of drilling sensors (7) could be used so long as the drilling sensors (7) which were used could provide the data that the particular drilling operator would like to use to assess the propriety of the drilling operations. Any number of drilling sensors (7) from one through to a large multiple number of sensors or sensor packages is contemplated within the scope of the present invention.

Shown in FIG. 7 also is a conventional well-logging truck (3). A well-logging truck (3) contains an instrumentation package which is used to log or monitor the conventional sensor data such as that described with respect to the process flow diagram in FIG. 1. Rather than using a proprietary drilling database (6) contained within the site computer (2), the system of the present invention could instead be interfaced to a pre-existing database of information. For example if an instrumentation kit such as the well logging truck (3) were already used or available it would be possible to apply the methodology of the present invention by simply interfacing the remainder of the intelligent system of the present invention with the sensor data logged within the pre-existing sensing or exploration package. It will be understood that either scenario, namely one or more drilling sensors being connected to the site computer which also hosted the drilling database, or a scenario in which the drilling database was hosted on a computer separate from the site computer and the drilling sensor or sensors were interfaced to that computer for the purpose of storing information to the drilling database, is specifically contemplated within the scope of the present invention. In another flavor of the same embodiments, the drilling sensors might be connected to a separate unit such as a well logging truck or the like which might be interfaced to the site computer where the site computer hosted the drilling database, and with the attendant necessary modifications to the connection between those components the sensory data related to the particular drilling sensors within the well could be stored to the drilling database. The key to operability of the system and method of the present invention in its reasonably broadest sense is that the terminus decision module (10) is executed by the site computer, and the drilling database is accessible thereto either by virtue of local residence on the site computer or by virtue of local or high speed network connectivity.

It is contemplated that the system (1) of the present invention could use or incorporate access to a drilling database (6) resident upon a conventional logging truck (3) such as the one that is shown or some other type of existing onsite sensor data source or stream, rather than needing to keep or capture a separate data stream. There is shown in this case, then, at (11) a sensor interface between the site computer (2) and the logging truck (3) which is effectively a communications interface between the site computer (2) and the logging truck (3) which will allow the site computer (2) of the system (1) of the present invention to access the logging data being captured already by the logging truck (3) and for use by the intelligent system (1) resident on the site computer (2).

For the sake of demonstration of the utility of the intelligent system (1) of the present invention in multi-axis drilling applications, it can also be seen that the well (16) which is being drilled in FIG. 7 is not straight. Specifically, a deviation in the drilling pattern is shown which is accomplished in accordance with conventional drilling methods, but again it is contemplated that the intelligent system (1) of the present invention will significantly enhance the utility of multi-directional drilling such as is shown here.

In operation of the system (1) shown in FIG. 7, the sensors (7) in the well are contemplated to be capable of capturing in a real-time or online fashion sensor data with respect to the well. Specifically, it is contemplated that the drilling sensors (7) would be monitored by the logging truck (3) during drilling operations and the terminus decision module (10) which comprises processor instructions and other necessary software components resident in or executable upon the site computer (2) could monitor the contents of the drilling log captured by the logging truck (3) during drilling operations for the purpose of assessing whether or not an appropriate terminus has been reached for the well and/or alternatively also information could be displayed to the operator of the drilling equipment pertaining to the potential redirection or realignment of the drilling tool (5). The reason that the logging truck (3) is shown here is to demonstrate the utility of the system and method of the present invention alongside or in conjunction with conventional equipment. It will be understood that the use of a logging truck (3) or other conventional logging or sensing equipment is contemplated within the scope of the present invention, as is the use of proprietary or specifically developed apparatus developed solely for the purpose of adding the functionality of the present invention to other applications or equipment.

Again it will be understood that showing the tool (5) in a withdrawn position from the well (16) while the sensors (7) are deployed is not intended to limit the scope of the present disclosure and invention to use in this fashion—it is specifically contemplated that the system (1) of the present invention could be used with the tool (5) in place in the well shaft (16), either while drilling is taking place or while drilling is stopped, and any necessary design modifications to the sensors or their system of deployment down the well to accomplish this objective are contemplated within the scope of the present invention.

Effectively, what is contemplated with respect to the system of FIGS. 5, 6 and 7 is that as sensory data is captured to the drilling database (6), the terminus decision module software resident upon the site computer (2) of the present invention is capable of applying either a fuzzy logic or computer based formula to the data being captured by the sensors (7) down the well to determine the existence of oil or gas at a particular drilling tool location and/or whether or not a particular location is at an appropriate point for termination of drilling operations.

A recommendation or display to the operator of the drilling equipment can be accomplished by attachment of a monitor or some other type of display to the site computer (2) of the present invention. Variosu methods of traditional human computer interface will be understood to one skilled in the art, and are all contemplated within the scope hereof. In a more automated version of the present invention, the site computer (2) could actually be directly interfaced to the drilling tool (5) and its related control equipment so that the drilling tool (5) could be controlled by the remainder of the intelligent system (1) of the present invention in accordance with the software resident on the site computer (2) of the system (1). Such a tool control interface is shown at reference (28) in FIG. 7.

The Computer:

At the core of the system (1) of the present invention is a site computer (2) with computer software resident therein which is capable of analyzing in real time sensory data captured to a drilling database (6) from sensors used in association with the drilling equipment or down the well.

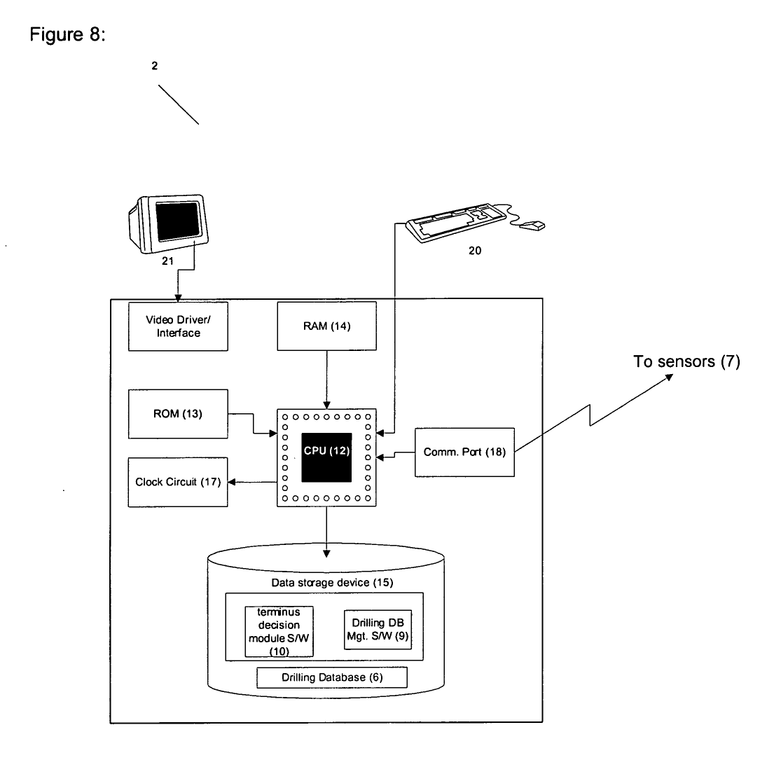

FIG. 8 is a block diagram of a preferred site computer (2) of the present invention. The computer (6) includes a CPU (12) which performs the processing functions of the site computer (2). It also comprises a memory system which might include read-only memory (13), random access memory (14) and disk or other storage space (15). The ROM (16) is used to store at least some of the program instructions that are to be executed by the CPU (12), such that portions of the operating system are software necessary to execute the transaction of the present invention. The RAM (14) is used for temporary storage of data and a clock circuit (17) provides a clock signal required by the CPU (12). The use of a CPU (12) in conjunction with ROM, RAM, disk space and the like, and a clock circuit, is well known to this skilled in the art of CPU-based electronic circuit design. The site computer (2) referred to herein means the combination of memory and storage devices used to retain data within the site computer (2) and exercise the application of the software outlined herein upon the data contained therein.

The site computer (2) in this case also includes at least one communications port (18) which is used to communicate with the sensors (7) outside of the site computer (2). The port (18) might be any type of an analog or digital interface capable of accepting and/or translating for recordal in the drilling database (6) on the site computer (2) readings from one or more sensors (7) down the well. It will be understood that where more than one sensor (7) is contemplated to be used within the scope of the present invention, the site computer (2) might also include more than one communications port (18) and that any number of communications ports (18) and attendant hardware for the purpose of translating or standardizing readouts or data recovered from various types of sensors (7) for recordal in a drilling database (6) in the site computer (2) are contemplated within the scope of the present invention.

The site computer (2), in its memory, includes a drilling database (6). The drilling database (6) contains a plurality of data readings from the various drilling sensors (7) which are in place or placed within the well to capture geological data with respect to the status of the well as it is being drilled, either in a shutdown or in a real-time online fashion. In addition, it also includes processor instructions, database management software components (9) and the terminus decision module software (10) which can be read and executed by a CPU (12) of the site computer (2) where necessary to extract or analyze certain data from the drilling database (6) in the practice or application of the remainder of the software application of the present invention. Also, other unrelated databases or software may be included on the site computer (2).

The site computer (2) might also include input means (20) such as a mouse, keyboard or combination thereof, in conjunction with a monitor (21). The input means (20) might interface directly with the CPU (12) such as shown in the figures, or alternatively an appropriate interface circuit (22) might be placed between the CPU (12) and the input means (20). The input means (20) is used by the user of the site computer (2) to interact, if at all, with the intelligent system software of the system (1) of the present invention.

The site computer (2) is capable of receiving readings or data from drilling sensors (7) down the well and recording the results of those sensor readings in a drilling database (6). The drilling database (6) can then be queried or used for the sake of analysis of the data contained therein to determine, based on the fuzzy inference system or other formulas contained within the terminus decision module software of the present invention, what might be an optimal drilling terminus or alternatively to determine the feasibility of continuing drilling in a particular direction down a well or in that well at all. The results of the application of the fuzzy logic system or other program to the data contained in the drilling database (6) can then be displayed to the user by way of the monitor (21) or other display.

It is contemplated that the system (1) of the present invention, insofar as the site computer (2) contains terminus decision module software capable of analyzing the data in real time contained within the drilling database (6), could either be programmed with one or more formulas for the analysis, comparison, blending or weighting of various sensory data captured to the drilling database (6), or alternatively a fuzzy inference system could be used as the terminus decision module. It is specifically contemplated that the optimal implantation of the terminus decision module would be a fuzzy inference system but a preprogrammed formulaic terminus decision module is also understood within the scope of the present invention.

It is specifically contemplated that what should be achieved using the system (1) of the present invention is the ability to use the terminus decision module of the present invention to provide simple and straightforward assessment and feedback on the analysis of various logs or sensor data captured from a particular well bore, either to augment manual human assessment of the data and the well drilling process by geologists, or alternatively to replace the need for manual geological assessment of the data on an ongoing basis as drilling takes place.

The specific degree of confidence placed in the data to be provided by the system of the present invention could vary from user to user—that is to say that some users might be prepared to switch entirely to the use of the terminus decision module (10) of the present invention in the place of a geologist, or some other companies might just want to use the system of the present invention to augment or assist geologists in maintaining control over the drilling process. It may even be the case, for example, that a drilling team may use the system of the present invention to reach a drilling terminus which the system has determined is either optimal for oil or gas extraction or alternatively where the system had maybe determined that the well was not feasible, at that point when a major decision such as to either withdraw the drilling tool (5) and commence extraction or alternatively to close off the well and abandon the bore were to be made, it may be at that point that the data identified or captured by the system of the present invention would be reviewed by a geologist.

It is desirable to provide outputs from the terminus decision module (10) of the present invention which are easily interpreted or understood by the users and which might identify only a fixed number of situations or scenarios. For example, the output from the terminus decision module (10) might be as simple as one of six different responses to the data which is contained in the drilling database (6). These responses might be as follows:
a) Profitable oil—this type of an output could tell the crew in a field that there is extractable oil in the well;
b) Unprofitable oil—this type of a feedback or result would inform the operators in the field that there is oil in the well, but the extraction of that oil is likely not profitable;
c) Gas—it could notify that there was gas in the formation;
d) Water—this output could tell the crew in the field that there is only water in the formation in question;
e) Discordance—when the sensors or data contained in the drilling database (6) were giving mixed information to the system such that a definitive decision can not be reached based on the rules programmed into the system, this type of a discordance message could be given to the users so that further appropriate action could be taken; or
f) No scale—some times the data captured in the logging of a well do not correspond with any known type of rock. In this particular case, an “no scale” message could appear as the output from the system of the present invention and, again, appropriate action could be taken by the users.

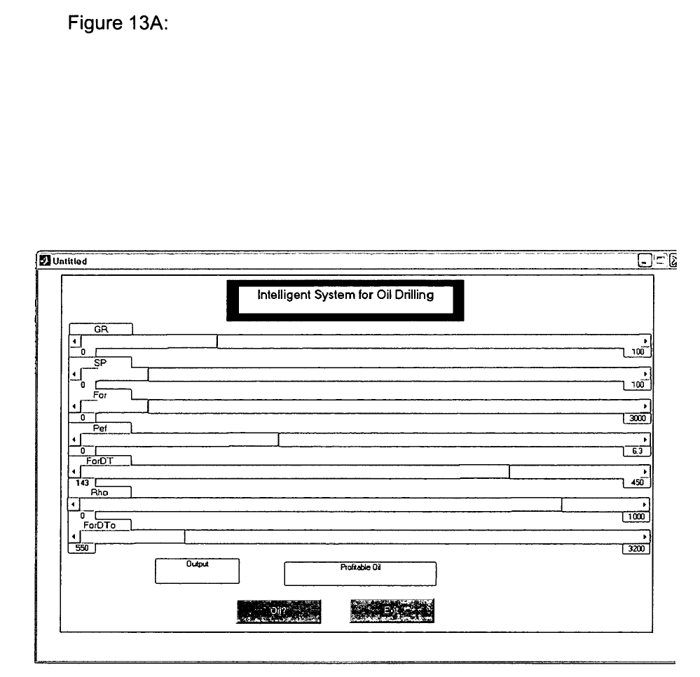

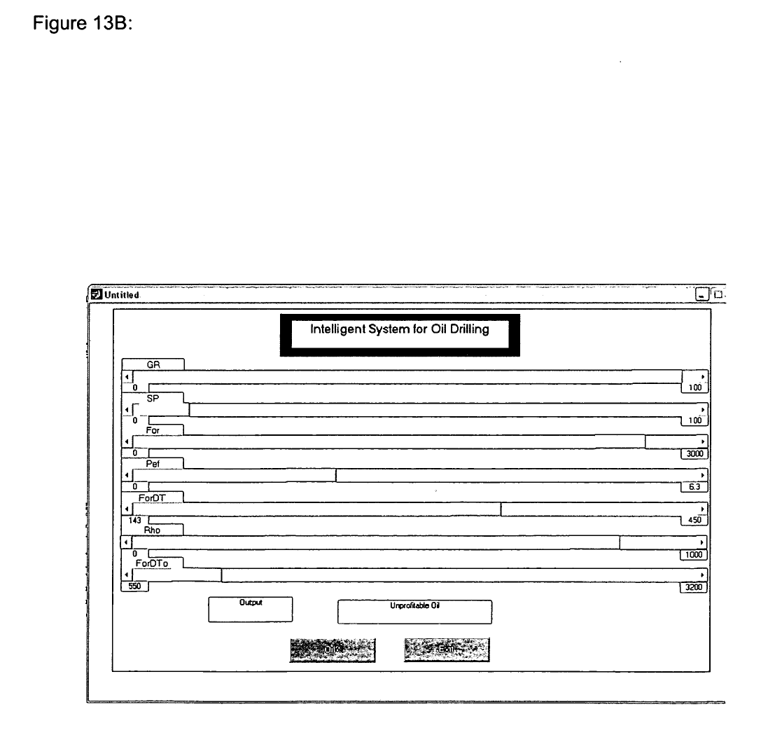

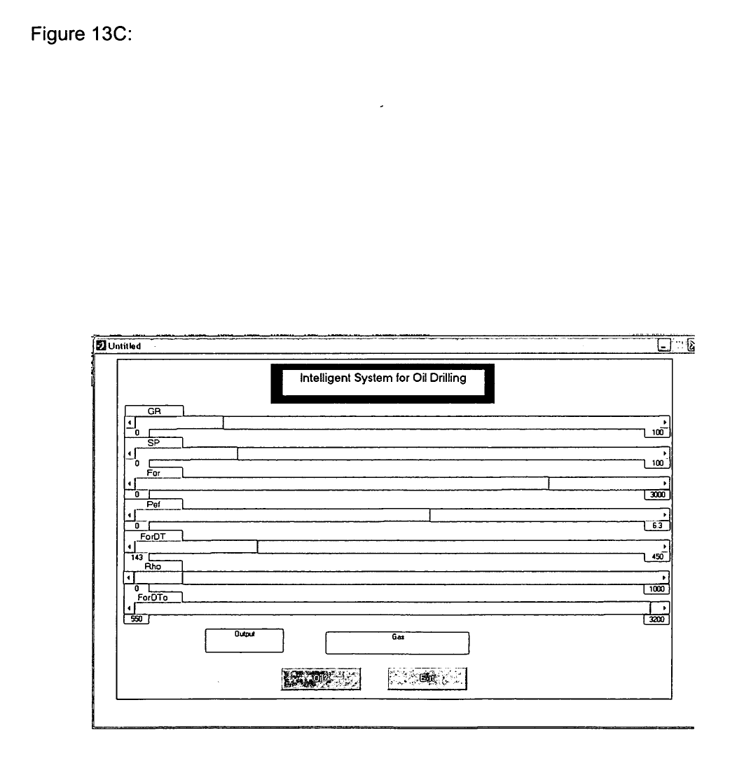

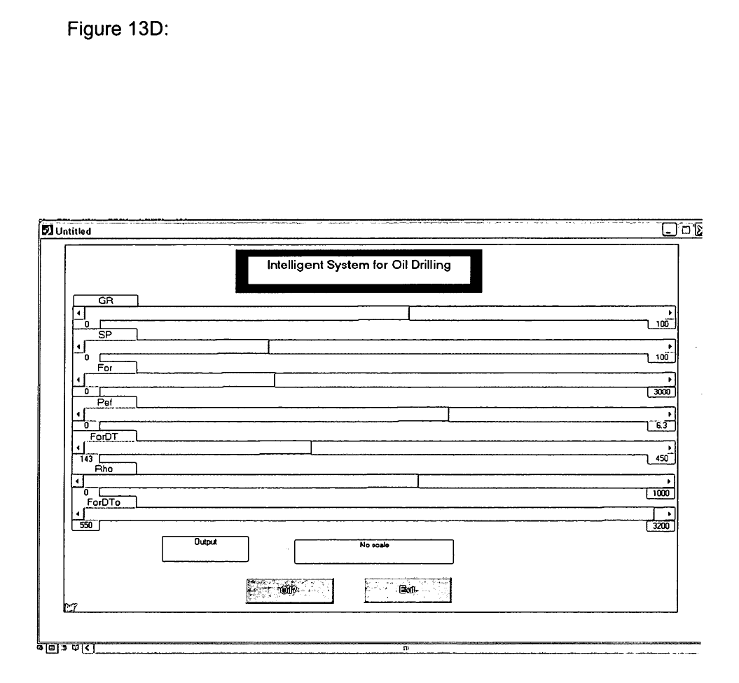

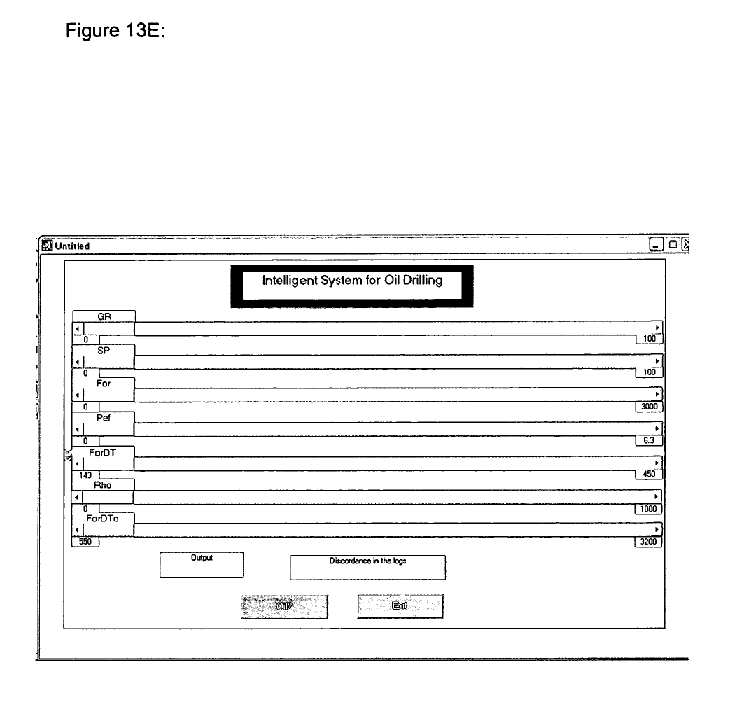

FIGS. 13A through 13D show one series of sample user interface screens that might be used in a system such as is presently proposed. The different screens can be seen to show the different sensor readings in question being analyzed, along with a recommendation or positioning result shown at the bottom of the screen. It will be understood that these Figures are merely demonstrative of the concept of providing a user interface with the present system and should not in any way be considered to restrict the scope of the type of user display or data displayed which might be employed with the method and apparatus of the present invention.

Sensory Data Inputs:

There are a number of different types of variables which typically would be used by a geologist in assessing whether or not there is extractable oil in a particular well or field being studied. Some of the most important variables or parameters that geologists use in assessing the presence of extractable oil in the field are porosity, saturation, permeability, temperature and pressure. This should in no way be considered an exhaustive list of the type of factors which can be used to determine the presence of oil or some other material which is being sought in a drilling application, but rather are the variables or parameters which are most often used by the geologists seeking or assessing the presence of oil in a particular field in an extractable form.

In one embodiment of the present invention, the system might analyze seven different sensory data streams such as those which are used conventionally by geologists in manually assessing the propriety and optimization of a drilling terminus in subterranean drilling applications. Table 1 shows the different types of sensory data inputs which might be used and captured in a drilling database (6) from the sensors (7) down the well, to yield, upon analysis and application of a number of rules to those inputs, a simple output result which is effectively an indication that there is extractable oil present at the particular location in question.

The combinations of the number and type of sensory data streams which could be used in the practice of the present invention is unlimited.

TABLE 1
Possible Input Types in Oil Drilling Applications

| Inputs | Outputs |
|---|---|
| GR (millielectron volt) | Extractable Oil |
| SP (millivolts) | |
| Formation Density (Kg/m3) | |
| Formation Density (fluid effect) | |
| Pef barns/e | |
| Formation DT | |
| Formation DT (fluid effect) | |

While it will be understood that any type of sensors (7) which might be considered useful by a particular drilling company or geology company for use in the proper or optimal assessment of drilling terminuss could be used in association with the system of the present invention, the following is a further description of the seven sample types of sensory inputs or readings listed in Table 1 above which are often times used by geologists in the analysis of the optimization of drilling termini, but also could be used by the terminus decision module (10) of the present invention similarly.

1. Gamma ray (GR)—Gamma ray analysis measures the total radioactivity of a particular geological formation. Gamma ray logs are used by geologists to identify many different types of important information, such as distinguishing potential permeable reservoir rocks (such as sandstone, limestone and bolomite) from non-permeable reservoir rocks (such as clay and shale), as well as to define bed foundries, tie a cased hole to an open hole log, give a qualitative indication of the shaliness of a particular formation, to monitor radioactive tracers or to aid in lithology (mineral identification). One of the reasons that the development of, for example, a fuzzy inference system or a terminus decision module (10) in any event with a number of fuzzy rules programmed therein, which will allow for the analysis and blending of different sensory data inputs to yield a probable result for display to a user is the fact that geologists have in the past developed tables for the interpretation of various types of these sensor data. The ranges of these tables will be the ones that could be programmed into the terminus decision module (10) of the present invention in order to analyze the data contained in the drilling database (6). For example, the following is a table showing some typical data for use in the analysis of a gamma ray log:

TABLE 2
Gamma Ray Data Interpretation
GR

| Formation | (millielectron volt) |
|---|---|
| Sandstone | 15 to 30 |
| (clean) | |
| Limestone | 10 to 20 |
| (clean) | |
| Dolmite | 8 to 15 |
| (clean) | |
| Anhydrite | 8 to 15 |
| Salt | 8 to 15 |
| Shale | >15 |
| Coal | <30 |

2. Spontaneous potential (SP)—An SP reading is the difference between the electrical potential (voltage) of a mobile electrode in the bore hole and the electrical potential of a fixed surface electrode. The SP log is used to identify impermeable zones, such as shale, and permeable zones, such as sand. As outlined above with respect to the gamma ray logging and assessment, there is also in existence tables of typical data ranges for use in the assessment of a spontaneous potential data stream. The following table displays one set of sample values or variables which could be used in assessing a particular spontaneous potential reading:

TABLE 3
Spontaneous Potential Data Interpretation
SP

| Formation | (millivolts) |
|---|---|
| Sandstone | <100 |
| (clean) | |
| Limestone | <100 |
| (clean) | |
| Dolmite | <100 |
| (clean) | |

3. Formation density—Formation density is a porosity log which can measure the electron density of a formation. This will assist geologists in a number of fashions, including the following. Firstly, formation density can be used to identify evaporate minerals. Evaporites are water-soluble, mineral sediments that result from the evaporation of saline water. Most evaporites are derived from bodies of sea water and evaporiate deposits would be very important in assessing a particular formation because they are subsurface traps for oil and gas. Formation density information can also be used to identify gas-bearing zones, to determine hydrocarbon density or to evaluate shaly sand reservoirs and complex lithologies. As outlined above with respect to the gamma ray logging and assessment, there is also in existence tables of typical data ranges for use in the assessment of a formation density data stream. The following table displays one set of sample values or variables which could be used in assessing a formation density reading:

TABLE 4
Formation Density Data Interpretation
Formation Density

| Formation | (Kg/m\hat{ }3) |
|---|---|
| Sandstone | <2650 |
| (clean) | |
| Limestone | <2710 |
| (clean) | |
| Dolmite | <2850 |
| (clean) | |
| Anhydrite | 2980 |
| Salt | 2030 |
| Shale | 2120 to 2760 |
| Coal | 1200 to 1500 |

Fluid Effect

| | |
|---|---|
| Water | Rho Water = 1000 |
| Oil | Rho Oil ˜850 |
| Gas | Rho Gas = 0 |

4. Photoelectric effect (Pef)—Photoelectric effect is a useful tool in determining the types of rock that are present in a formation. As outlined above with respect to the gamma ray logging and assessment, there is also in existence tables of typical data ranges for use in the assessment of a photoelectric effect data stream. The following table displays one set of sample values or variables which could be used in assessing a photoelectric effect reading:

TABLE 5
Photoelectric Effect Data Interpretation
Pef

| Formation | (barns/e) |
|---|---|
| Sandstone | 1.8 |
| (clean) | |
| Limestone | 5.1 |
| (clean) | |
| Dolmite | 3.1 |
| (clean) | |
| Anhydrite | 5 |
| Salt | 4.6 |
| Shale | 1.8 to 6.3 |
| Coal | <1 |

5. Formation DT—This is a sonic or acoustic log which measures acoustic energy, which is sent by a transmitter through the formation in the bore hole. This type of data can be used in combination with other data for assessing porosity, shaliness and lithology. As outlined above with respect to the gamma ray logging and assessment, there is also in existence tables of typical data ranges for use in the assessment of a formation DT data stream. The following table displays one set of sample values or variables which could be used in assessing a formation DT reading:

TABLE 6
Photoelectric Effect Data Interpretation
Formation Density

| Formation | (micro seconds/m) |
|---|---|
| Sandstone | >182 |
| (clean) | |
| Limestone | >156 |
| (clean) | |
| Dolmite | >143 |
| (clean) | |
| Anhydrite | 164 |
| Salt | 219 |
| Shale | ˜328 |
| Coal | ˜400 |

Fluid Effect

| | |
|---|---|
| Water | DT Water = 620 |
| Oil | DT Oil ˜750 |
| Gas | DT Gas >3000 |

Again, these types of sensor inputs and data types which could be used by the system of the present invention are intended only to illustrate the utility of the system. Basically, any type of a sensory data feed which could be recorded could be factored into the fuzzy rules or formulas programmed in the remainder of the system for use or assessment in the practice of the method of the present invention.

Drilling Database:

The drilling database (6) would contain the sensory data reported from the one or more sensors (7) used in the drilling of the well, and the readouts from which will be used by the remainder of the system (1) to calculate or determine the appropriate terminus of a particular well. For example, in respect of one particular system in accordance with the present invention, it may be the case that only one sensor was used and, on that basis, one type of information only was going to be analyzed or monitored with a view to assessing the appropriate terminus for the well. In that case, only one stream of sensory data would be stored in the drilling database (6). This would be different from another embodiment in which perhaps five or more different types of sensors (7) would be used in the various instrumentation of the present system on the well to provide five different sensory data streams for analysis by the software and system of the present invention for the determination of the appropriate drilling terminus based on the blending or weighting of the various data streams and the results by the system of the present invention. In that particular case, it may be that there were five or more different data streams stored in some convenient fashion within the drilling database (6). It may in fact be the case that the same drilling database (6) could be programmed for use with a variable number of sensors (7) so that, either automatically or by some type of a user adjustment, the database (6) would automatically have the capacity or capability of capturing or storing data streams from a variable number of sensors (7) to be set or determined by the system (1) or the user at the time of its use. It will be understood that this additional level of flexibility, as well as the possibility of using a database with a fixed table structure and design for a fixed or specific number of sensors to store sensory data captured during the drilling of a well are all contemplated within the scope of the present invention.

The site computer (2) of the drilling system (1) of the present invention includes software which, through various components, would carry out the administration and operation of the method and system of the present invention. One aspect of the computer program (8) could be a drilling database maintenance component (9), which would be responsible for the upkeep of records in the drilling database (6) pertaining to various sensor readings or inputs captured or determined during the drilling of a particular well.

The drilling database (6) would be stored in the memory of the site computer (2) and the drilling database maintenance component (9) could be any software component capable of accessing and administering this database (6). It will be understood that the precise structure of the database (6) could be any type of database structure which could be administered by a software component (9) in the site computer (2) and that all types of data structures are contemplated within the scope of the present invention.

One function of the drilling database maintenance component (9) could be to maintain or record any changes or additions made to records of the drilling database (6) as a result of or during the capture of various sensory data during the drilling of a well. As well, the drilling database maintenance component (9) could be responsible for serving information from the drilling database (6) either to other software components within the site computer (2) or to other network components or computers at the drilling site which the data contained in the drilling database (6) might be useful or required for use either in the scope of the present invention or for other non-related purposes.

The information which might be contained within the drilling database (6) with respect to each sensor reading might include specifics of the type of sensor (7) used to capture the particular reading, and/or one or more parameters or readings from the sensor (7) at the particular time or drilling depth in question. The time or drilling depth at which the particular sensor reading was captured might also be included within the records of the drilling database (6) pertaining to individual readings contained therein. It would be key for the utility of the system of the present invention to determine, either by way of a time or drilling depth, the particular location at which a reading was taken in order to provide the system (1) or the operator of the system with appropriate feedback or instructions regarding the determination of an appropriate drilling terminus by the system of the present invention. It may also be the case that the information stored with respect to particular sensor readings which had been captured by the system of the present invention in the drilling database (6) might also include other information pertaining to different settings or location of the drilling tool (5) at the time that the reading were taken.

It will be understood by one skilled in the art that various different types of information could be captured and stored within a drilling database (6) as contemplated within the scope of the present invention, and it will be understood that any modifications to the particular content or structure of a drilling database (6), insofar as it does not detract or depart from the scope of functionality of the system outlined herein, are all contemplated within the scope of the present invention as well.

It will be understood that the drilling database (6), insofar as it is required for the operation of the remainder of the system (1) of the present invention, might either be a database and related components stored or operated within or by the system (1) of the present invention, or alternatively the drilling database (6) shown in the figures and specification herein could be replaced by an interface or access by the system of the present invention to another database containing the necessary sensory data related to the drilling of a well, upon which the remainder of the intelligent system of the present invention could be practiced. It will be understood that the use of an internal or proprietary database (6) in the system of the present invention, or the interfacing of the remainder of the system (1) of the present invention within an external database which already contained one or more streams of sensory data with respect to the well being drilled, are both contemplated within the scope of the present invention.

Terminus Decision Module Software:

A terminus decision module (10) software component is also present in the site computer (2), and it is this terminus decision module (10) which will actually conduct the real time assessment of sensory data contained within the drilling database (6).

In the embodiments shown, the terminus decision module (10) will interface directly or indirectly with the drilling database (6) for the purpose of accessing and analyzing sensory data captured from the drilling of the well, as well as for, at the appropriate time, selecting an optimized drilling terminus with respect to the well being drilled.

It is effectively contemplated that the terminus decision module component (10) will in fact comprise a fuzzy inference system (FIS) based on fuzzy logic techniques. Fuzzy logic is a type of logic that recognizes more than simple true and false or Boolean logic values. Effectively, in a fuzzy logic system there are no absolute answers for every problem, and there can be different answers for every specific problem or every situation depending on the variables available to the system. One of the benefits of the use of a fuzzy inference system in the terminus decision module component (10) of the present invention is that various drilling situations can be confronted in a straightforward and systematic way, regardless of any uncertainty or ambiguity apparent to the user with respect to the data. Also, when necessary, a fuzzy inference system such as is contemplated for use herein can be modified rather easily. Specifically, the fuzzy inference system might be modified for different users if different drilling companies, for example, prefer to place a different weighting on the use of different types of sensory data in the rendering of expert advice from the terminus decision module (10) of the present invention with respect to the location of the optimal drilling terminus.

In this particular case, the fuzzy inference system which is contemplated might be used in the analysis or review of the sensory data captured in the drilling database (6) effectively has the purpose of taking the sensory data captured in the drilling database (6) and, based upon a set of fuzzy rules and membership functions programmed into the fuzzy inference system, analyzing, or weighting, those data to yield a set of outputs based on the data. The fuzzy rules and membership functions in a fuzzy inference system constitute the relationships between the inputs and the outputs. The fuzzy rules and membership functions need to effectively represent the system behavior and how the inputs, outputs depend on each other. Basically, a number of rules can be determined for use in the analysis of the data captured within the drilling database (6) from the drilling sensors (7) down the well, which will take into account all the different possible situations which could be found in an oil drilling process to yield a set of outputs from those fuzzy rules which are of some utility or use to the operator of the drilling equipment.

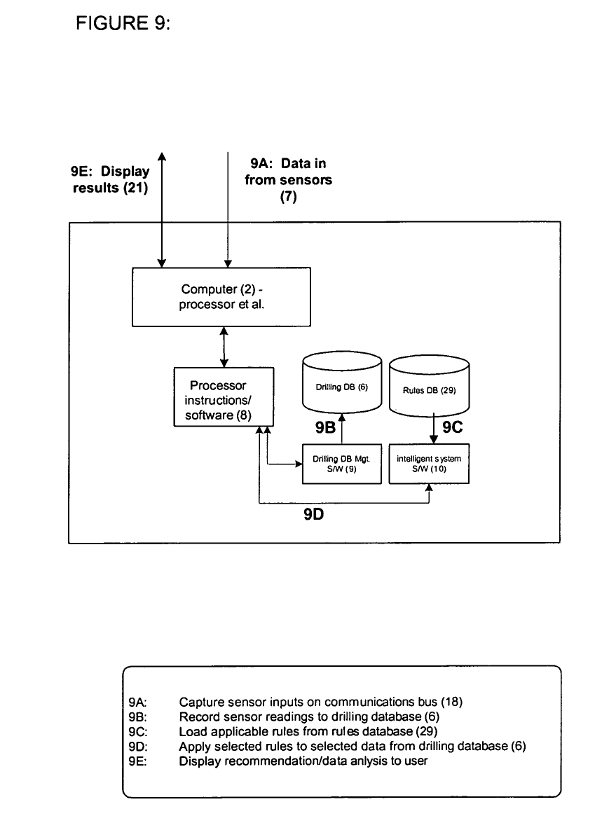

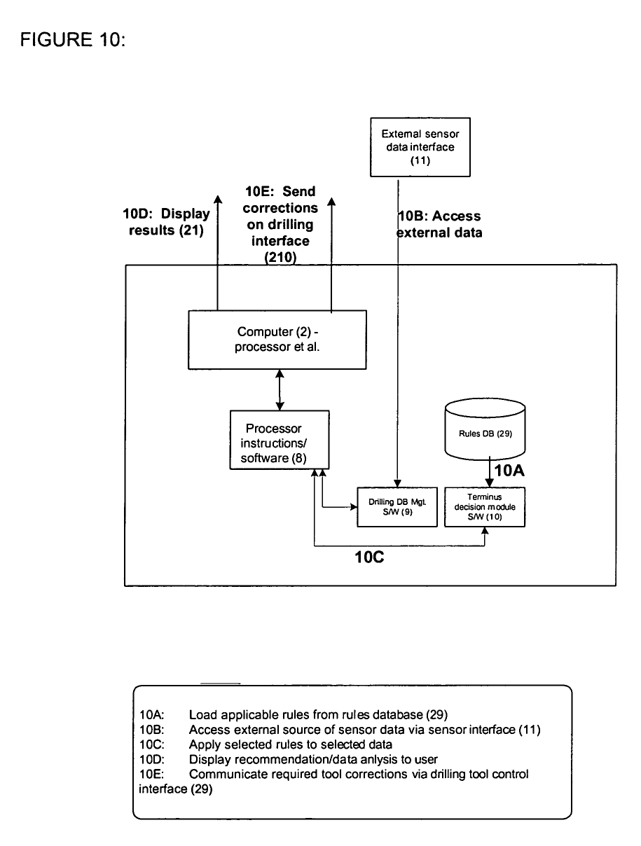

FIGS. 9 and 10 demonstrate sample data flow and actions in the terminus decision module (10) of the present invention. Referring first to FIG. 9 there is shown a sample data flow diagram demonstrating the main software and electronic interface elements involved in the operation of the method of the present invention by the site computer (2) of the present invention. This Figure will be used to describe the typical behavior and flow of data in the embodiment shown of the present invention. To analogize the circumstances or external system related to the data flow shown in FIG. 9, the embodiment of FIG. 9 is likely similar to or the type of general data flow which would be used in the physical embodiment of the system (2) shown in FIG. 4, namely with an internal drilling database (6) and no direct drilling control interface (28).

In operation of the software of the present invention as shown in FIG. 9, the first step which is shown, at 9A, is the capture of sensor data from the sensor or sensors (7) being used in the well. The capture of the sensor data by the communications bus in the site computer (2) at 9A would be followed by the recordal of that data into the drilling database (6) by the computer software (8) and specifically by any database maintenance component (9) which might be present on the system of the present invention, which is shown at 9B. Effectively then upon reaching Step 9B, data has been captured from the sensors (7) in place or used down the well (16) and has been properly catalogued or indexed into the drilling database (6) for subsequent use by the remainder of the system.

The next step in the software method of the present invention will be the periodic or continuous assessment of the data logged into the drilling database (6). As discussed in greater detail herein, the analysis of the logged data from the drilling database (6) could either take place on an intermittent basis—i.e. when a drilling stop is made, the log is examined—or alternatively could be scheduled such that, for example, the data in the database (6) would be assessed by the remainder of the system every five minutes. In an extreme online variety of the method of the present invention, the sensor data could actually be assessed in an ongoing real-time fashion as it is logged into the database (6). It will be understood that all such methods of assessment of the data—from an ad hoc approach where assessment was triggered by an operator as a scheduled periodic review through to continuous online assessment—are contemplated within the scope of the present invention.

In any event at such time as the system is prompted to review and assess the data, either in an ad hoc fashion or by some predetermined schedule, the terminus decision module (10) resident in the site computer (2) will be loaded or accessed by the processor.

In the embodiment of FIG. 9 a rules database (29) is shown in which the various fuzzy rules to be applied by the intelligent system component (10) in assessing or weighting the various sensor data captured to the drilling database (6) are stored. It will be understood that there may be no physically separate rules database (29) and that the fuzzy rules or formulas used to weight and assess the various types of sensor data might even be hard-coded into the remainder of the terminus decision module (10) but the use of a rules database, particularly where a fuzzy inference system were to be employed, has some attraction in terms of its accessibility both from a programming and use perspective—the contents of the rules database (29) could be easily changed or updated without a need for recompiling or reinstalling other software components. However it will be understood that any programming method resulting in the necessary business rules or formulas being properly programmed to the satisfaction of a particular user is contemplated within the scope of the present invention.

In the embodiment shown in FIG. 9, the terminus decision module (10) will load up the proper fuzzy rules from the rules database (29) which are to be used with the particular types of sensors being deployed in the drilling of this particular well. This is shown at Step 9C. This will be key as a step not only to have the software ready for its particular instant use, but also again the customization ability of the present system is demonstrated—for example the rules database (29) or the software (10) may have all of the necessary rules or formulas contained therein for the use of many different types of sensors (7), and the system could then automatically apply the fuzzy rules for the particular types of sensors being used at that time either by automatically detecting the types of sensors or data to be assessed, or by presenting some type of a selection interface to the user through the site computer (2), which would allow the user to stipulate or indicate the type of sensors or data to be used. This would allow different sensors to be used in the drilling of different wells without the need to reprogram the system each time, or alternatively would even allow for the types of sensors to be switched during the drilling of a particular well without requiring a major upgrade or refitting of the computer interface.

The next step in the data flow of FIG. 9 is to apply the selected fuzzy rules from the rules database (29) to the relevant data subset from the drilling database (6)—the terminus decision module (10), in conjunction with the drilling database (6) and any other necessary software components would apply the fuzzy rules or other calculations specified by the selected rules to the data selected for assessment from the drilling database (6). This is shown at Step 9D in the Figure.

Step 9E then is the display of the results of the application of the selected fuzzy rules or assessment to the sensor data in question from the drilling database (6). The results being displayed to the user can then be used to take appropriate action such as to cease drilling, continue drilling or make whatever other drilling adjustments might be desired.

FIG. 10 demonstrates the data flow in another embodiment of the terminus decision module (10) of the present invention. The data flow show in FIG. 10 would correspond more closely to the physical embodiment of the system shown in FIG. 7, insofar as this embodiment incorporates an interface with an external drilling database or source of sensory data, and a direct drilling control interface is also referenced. Shown at Steps 10A and 10B in this Figure is the loading of the appropriate fuzzy rules from the rules database (29)—again as outlined above the specific form of the software at the end of the day may or may not include a specific rules database (29), but the use of a separate database or the coding of the necessary rules or formulas into the remainder of the software (8) resident on the system is contemplated within the scope of the present invention.

The embodiment of FIG. 10 shows an external sensor data interface (11) connected to an external source of sensor data such as the logging truck 3 shown in FIG. 7. Once the terminus decision module (10) has access to the necessary rules or system information along with the relevant set of sensor data from the external source, the acquisition or access to which is shown at 10B, the data can be assessed. The assessment of the data by the terminus decision module based on the fuzzy rules required is shown at Step 10C. Step 10D then is the display of the results of the application of the selected fuzzy rules or assessment to the sensor data in question. The results being displayed to the user can then be used to take appropriate action such as to cease drilling, continue drilling or make whatever other drilling adjustments might be desired.

Shown at Step 10E is a further control enhancement which can be accomplished using the system of the present invention—basically if the formulas or fuzzy rules within the terminus decision module (10) can be programmed appropriately to not only generate recommendations or data display for the drilling operators but also to potentially generate instructions or corrections for the direction or aspect of the drilling tool in multi-axis drilling applications, the software (10) could send an appropriate correction instruction or tool adjustment data to the control system of the drilling equipment (4)/(5) via a drilling tool control interface (28). It may or may not be the case that operators would ever evolve the system or their trust of the system to the point that they would trust the system to entirely on its own direct the drilling of a well, but it is conceptually foreseeable that this could be accomplished in this fashion.

One of the benefits of the use of a fuzzy inference system to analyze sensory data captured in a drilling database (6) such as that of the system (1) of the present invention, is that the software or fuzzy rules which are used to analyze the data can be adjusted for individual users or situations. For example, a particular operator of drilling equipment may have their own personal weighting formula or weighting preferences which they use in analyzing multiple streams of sensory data to determine the propriety of a drilling terminus. By simply adjusting the fuzzy rules in a fuzzy inference system or adjusting the weighting formula in the terminus decision module of the present invention, the output from the system can be tailored to the needs or desires of the particular user, based on the same types of sensory inputs.

Also, the software of the present invention, in addition to being customized to individual user needs, can also be customizable insofar as different types of sensors could be used. For example, one operator at one drilling site might use three sensors of particular types, and at another drilling site may wish to add five other types of sensors which are used in particular geological conditions or the like to enhance the accuracy of the sampling or the analysis which can be conducted based on the data. The terminus decision module could be designed to automatically recognize the type of sensor data contained within the drilling database (6) and automatically adjust the formula or fuzzy rules to be applied to that data and yielding results to the operator, or could have an interface whereby the user could select the types of sensory data to be used and also the nature of the rules set of formulas to be applied to that data in yielding results.

It will be understood that any such modifications to the general concept of the use of a computer software or fuzzy based system to analyze drilling sensor data and produce or provide a display or output of the results or outputs calculated based upon the input of those data to a user are contemplated within the scope of the present invention.

It is contemplated with respect to the terminus decision module software of the system of the present invention that either a fuzzy inference system, as demonstrated or discussed in more detail herein, could be used or alternatively some type of other non-fuzzy computer implemented formula software could be designed for analysis of a particular type of sensor data contained therein. The use of either a terminus decision module which effectively constitutes a fuzzy inference system such as is discussed herein, or alternatively a non-fuzzy computer implemented formula terminus decision module to analyze the sensory data streams in a particular application, are contemplated within the scope of the present invention.

Instrumentation Kit for Existing Site Computer:

In addition to the production of a personal computer or other electronic hardware which was self-contained and completely capable of the practice and implementation of the method of the present invention for capturing sensory data through to the operation of the intelligent system software and subsequent feedback of results to the user, it is also contemplated that there could be designed an instrumentation add-on for use on an existing computer at a drilling site.

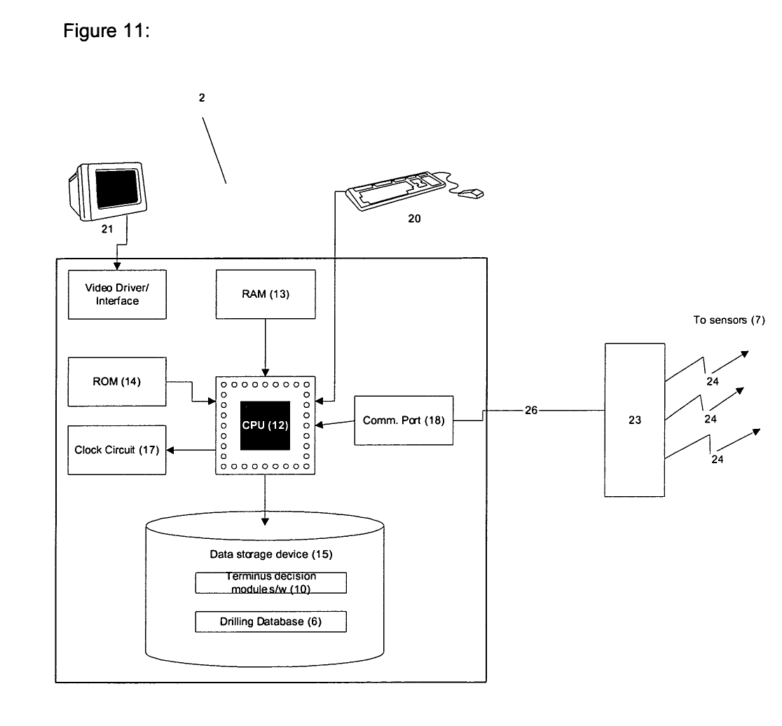

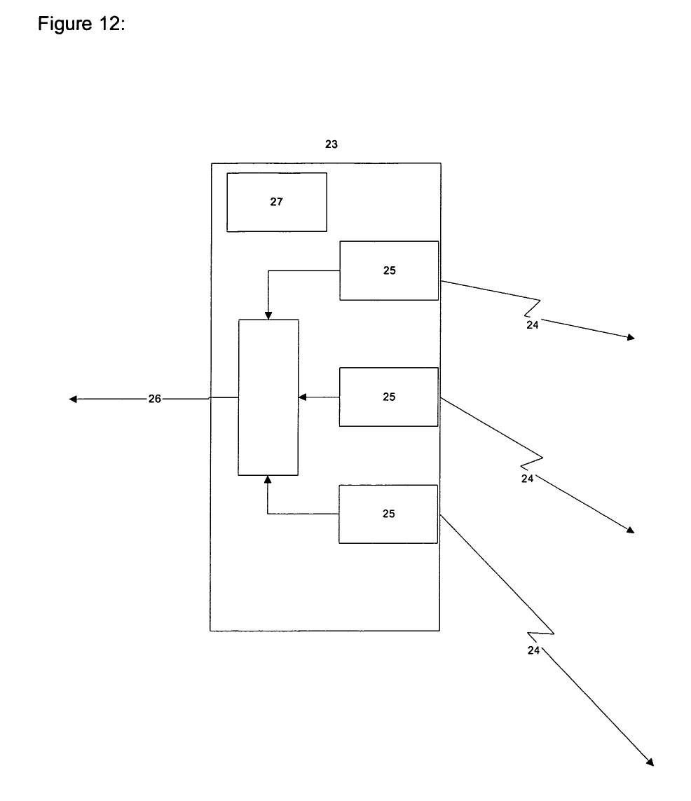

It may be the case that a drilling site has an existing PC or other computer which has additional computing capacity so that it could be used to practice the method of the present invention. Referring first to FIG. 11, there is shown the same embodiment of a computer as that of FIG. 8, however rather than having the sensor or sensors connected directly to one or more communication ports (18) on the site computer (2), the sensor or sensors (7) are connected to the site computer (2) by way of an external sensory interface unit (23). FIGS. 9 and 10 show one embodiment of a sensory interface unit (23) which is contemplated within the scope of the present invention.

Effectively, the sensory interface unit (23) is an external hardware component capable of connection to one or more sensors (7) that are used down the well, and the sensory interface box (23) would be capable of converting the signals or data received from the sensor or sensors (7) into standardized digital signals which could be fed to a PC such as that shown in FIG. 9 by way of a communications port (18) or the like. Referring in detail to the sensory interface unit (23) shown in FIG. 10, there is shown a sensory interface unit (23) capable of connection in this case to three sensors (7). Each of the sensor connections is shown as a sensor connection (24) and could be any kind of a port which is capable of accepting whatever type of a cable or wire or other output was used with respect to a particular sensor (7). Shown next in FIG. 10 at (25) are three separate sensory input conversion circuits, which would be any circuit which was capable of converting the signal or output to be received from a particular type of sensor (7) into a signal or output that was capable of being transmitted to or read by the remainder of the site computer (2) to which the sensory instrumentation unit (25) was connected. It is specifically contemplated that each of these sensory input circuits (25) might be different insofar as different types of circuits might be required to standardize or convert different sensor outputs into the standardized signals required to be communicated to or received by the site computer (2) connected to the sensory interface unit (23). It might be contemplated that a particular sensory interface unit (23) could be produced with more than the quantity of typically used sensory interface circuits (25) contained therein so that at a particular drilling site the user could select the types of sensors (7) to be used. In any event, the three sensory input circuits (25) are shown connected to a communications interface (23), which sensory communications interface (23) is in turn connected to a PC or site computer (2) by way of an external port or cable (18). Any type of a input circuit (25) capable of converting a particular sensor signal or output to a standardized singal for passthorugh to and recordal in a drilling database are contemplated within the scope of the present invention. It may also be the case that certain sensors already provide a standardized digital output in which case the input circuit if any used therwith might be a simple passthrough circuit.

Use in Horizontal or Multiple-Axis Drilling Applications:

It is also contemplated that the present invention could be used in horizontal drilling applications. Conventional drilling took place effectively by either drilling straight down from the drilling derrick on the surface, or alternatively to obtain a slightly angled but still straight-bored drilling hole, the derrick could be slightly angled on the surface with the tool then inserted into the ground on a slight (twist, jaw, and/or pitch, for example) angle, but still extending effectively straight down from the bottom planer surface of the drilling derrick. It is now the case that drilling tools and equipment are available which allow for effectively a three-axis movement of the drilling tool beneath the surface as drilling takes place—that is to say that the tool cannot only be moved up and down, but from side to side on two different axis as well. It is contemplated that with proper sensors (7) feeding information to the system of the present invention, the programming and software involved in the apparatus and method of the present invention could be altered to allow for the proper three-dimensional direction of the drilling tool rather than simply determining whether the tool should be run further down or back up in a straight-bored hole. It will be understood that any necessary amendments or changes to the system of the present invention which would allow the system to accomplish this goal of allowing for the onsite and real time direction of a three-axis drilling tool is also contemplated within the scope of the present invention.

Integration of the System of the Present Invention with Drilling Tool Controls:

In the case of an “online” embodiment of the apparatus or method of the present invention as outlined above, where the sensor data is monitored by the computer system as the drilling tool is in operation rather than by requiring logging shutdowns within which time sensor data from the hole can be obtained, it will also be contemplated and understood by anyone skilled in the art that the system of the present invention could be directly integrated with the control system for the drilling tool in such a three-dimensional application to allow for effectively real time direction of the drilling tool, in a down-hole fashion, based on an ongoing and virtually instantaneous assessment of sensor data received by the system of the present invention.

It is contemplated that the system of the present invention could either be used in a fashion whereby analysis conducted by the system or in accordance with the method of the present invention would result in the display or provision of data or materials to the operators of the drilling equipment which would indicate to them the proper location for the drilling tool and/or whether or not it needed to be moved up or down the hole, or the like. It will also be understood, however, that with attendant non-substantive modifications, the system of the present invention could potentially be directly interfaced to the control system for the drilling tool such that in an online fashion the system of the present invention could effectively control the depth of the tool directly rather than relying in any way, shape or form upon the input or supervision of human operators of the drilling equipment. Specifically, that it to say that if the system were properly integrated with the control system of the drilling tool, if the system of the present invention determined that the appropriate drilling depth or terminus had been reached, it could automatically cease the drilling activity of the derrick. Alternatively, if it determined that the oil formation had been overshot by the drilling tool, it could automatically pull the tool back or again cease drilling. Similarly, if it were to determine that the drilling had undershot the desired oil formation, the drilling tool could automatically be controlled or made to continue drilling until the appropriate depth had been reached. It will be understood that any such modification to the system and method of the present invention is contemplated within the scope hereof as well.

Summary:

Overall then it can be seen from the discussion herein the scope and nature of the present invention as contemplated. The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A method of locating a drilling terminus during the drilling of a subterranean well at a predetermined drilling site using a drilling tool, said method comprising:
a. A data capture step, comprising during the drilling of the well capturing at least one drilling data stream comprising sensory drilling data from at least one drilling sensor within the well, being drilling data, and storing said drilling data with reference to the specific location within the well at which such drilling data was captured within a drilling database resident upon a computer interfaced to said at least one drilling sensor;
b. A data analysis step comprising, using a site computer located at the drilling site and software thereon comprising at least a terminus decision module, assessing the desirability of specific locations within the well as drilling termini based upon the comparison of the location-referenced drilling data with respect to each such specific location contained within the drilling database to at least one terminus decision criteria;
wherein drilling of the well can be altered based upon the determination during the data analysis step that the desired drilling terminus has not yet been reached;
or wherein drilling of the well can be stopped based upon the determination during the data analysis step that a specific location within the well which has been reached by the drilling tool comprises the desired drilling terminus.

2. The method of claim 1 wherein the data analysis step takes place after the completion of the data capture step.

3. The method of claim 1 wherein the data capture step and the data analysis step take place coincidentally.

4. The method of claim 3 wherein the drilling tool is operational during the data capture step.

5. The method of claim 1 wherein the drilling tool is removed from the well during the data capture step.

6. The method of claim 5 wherein the drilling tool is removed from the well and the data capture step commenced upon the reaching of a particular selected logging location in the well by the drilling tool.

7. The method of claim 1 wherein the results of the data analysis step are displayed to operators of the drilling tool by a human interface.

8. The method of claim 1 wherein the site computer is interfaced to the drilling tool via a drilling tool control interface, and whereby the drilling tool can be automatically controlled based upon the results of the data analysis step by the passing of control instructions to the drilling tool from the site computer via the drilling tool control interface.

9. The method of claim 1 further comprising the step of triggering the cessation of drilling upon determination that the desired drilling terminus has been reached.

10. The method of claim 1 further comprising the step of continuing the drilling of the well upon determination that a desired drilling terminus has not been reached based on the assessment of the drilling data contained within the drilling database during the data analysis step.

11. The method of claim 1 wherein the assessment of the drilling data contained within the drilling database, during the data analysis step, includes an assessment or decision as to whether or not the drilling of the well should be stopped on the basis that a desirable drilling terminus is not going to be reached.

12. The method of claim 1 wherein said at least one terminus decision criteria is a fixed formula, and the comparison of location-referenced drilling data thereto comprises a calculation of that formula based upon the location-referenced drilling data in question and comparing the results of that formula to a predefined range of desirable results.

13. The method of claim 1 wherein the terminus decision module is a fuzzy inference system capable of rendering recommendations regarding the propriety of particular specific locations within the well as desirable drilling termini based upon comparison of all of the relevant terminus decision criteria to the drilling data stored within the drilling database with respect to such specific locations.

14. The method of claim 1 further comprising a rules database within which said at least one terminus decision criteria is stored.

15. The method of claim 1 wherein the terminus decision module will automatically select and apply the appropriate terminus decision criteria based upon the nature and number of drilling sensors from which drilling sensory data is being stored to the drilling database.

16. The method of claim 1 wherein the drilling tool remains within the well during the capture of the at least one drilling data stream.

17. The method of claim 1 further comprising removal of the drilling tool from the well upon the determination by the terminus decision module that an appropriate drilling terminus has been reached.

18. The method of claim 11 further comprising removal of the drilling tool from the well upon the determination by the terminus decision module that an appropriate drilling terminus is not going to be reached.

19. An intelligent system for use in locating a drilling terminus during the drilling of a subterranean well at a drilling site with a drilling tool, said system comprising:
a. At least one drilling sensor for use within the well to capture sensory drilling data with respect to specific locations within the well in at least one drilling data streams;
b. A drilling database for storage of drilling data measured by the at least one drilling sensor within the well, said drilling data being stored with reference to the specific location within the well at which such drilling data was captured, said drilling database being hosted on a computer located at the drilling site;
c. An interface between said at least one drilling sensor and the computer hosting the drilling database facilitating the capture of said at least one drilling data stream to the drilling database;
d. software operative on a site computer located at the drilling site comprising at least a terminus decision module which will assess the desirability of specific locations within the well as drilling termini based upon the comparison of the location-referenced drilling data with respect to each such specific location contained within the drilling database to at least one terminus decision criteria; and
e. A user interface operatively connected to the site computer, said user interface capable of rendering the results of the assessment of desirability of specific locations conducted by the terminus selection module, for use in operation of the drilling tool;
Wherein drilling of the well can be altered or stopped based upon the determination by the terminus decision module of the propriety of any particular specific location within the well as a drilling terminus.

20. The system of claim 19 wherein the computer on which the drilling database is hosted is the site computer.

21. The system of claim 19 wherein the computer on which the drilling database is hosted is not the site computer, and wherein the computer on which the drilling database is hosted is operatively connected to the site computer so that software on the site computer can access the drilling database.

22. The system of claim 19 wherein the user interface is a human interface by which the results of the assessment of the propriety of specific locations within the well as drilling termini are displayed to the operator of the drilling tool for human interpretation and action.

23. The system of claim 19 wherein the user interface is a drilling tool control interface between the site computer and the drilling tool, wherein adjustments or corrections to the settings of the drilling tool can be automatically communicated from the site computer based on the assessment of the drilling data contained within the drilling database.

24. The system of claim 19 further comprising at least one drilling tool for the drilling of the subterranean well.

25. The system of claim 19 wherein said at least one drilling sensor is capable of being present in the well at the same time as a drilling tool.

26. The system of claim 25 wherein drilling data from the at least one drilling sensor can be captured and recorded to the drilling database during the drilling of the well by the drilling tool.

27. The system of claim 19 wherein said at least one terminus decision criteria is a fixed formula, and the comparison of location-referenced drilling data thereto comprises a calculation of that formula based upon the location-referenced drilling data in question and comparing the results of that formula to a predefined range of desirable results.

28. The system of claim 19 wherein the terminus decision module is a fuzzy inference system capable of rendering recommendations regarding the propriety of particular specific locations within the well as desirable drilling termini based upon comparison of all of the relevant terminus decision criteria to the drilling data stored within the drilling database with respect to such specific locations.

29. The system of claim 19 further comprising a rules database within which said at least one terminus decision criteria is stored.

30. The system of claim 19 wherein the terminus decision module will automatically select and apply the appropriate terminus decision criteria based upon the nature and number of drilling sensors from which drilling sensory data is being stored to the drilling database.

31. A site computer for use in locating a drilling terminus during the drilling of a subterranean well at a drilling site with a drilling tool, said site computer comprising:
a. a sensor interface for connection of said site computer to at least one drilling sensor in the well;
b. a drilling database accessible to said site computer to which drilling data from said at least one drilling sensor can be stored when received by said site computer via the sensor interface, said drilling data being stored in the drilling database along with location-referencing coordinates related to the specific location within the well from which said drilling data was measured; and
c. Software comprising a terminus decision module which will assess the desirability of specific locations within the well as drilling termini based upon the comparison of the location-referenced drilling data with respect to each such specific location contained within the drilling database to at least one terminus decision criteria; and
d. A user output capable of rendering the results of the assessment of desirability of specific locations conducted by the terminus decision module, wherein drilling of the well can be altered or stopped based upon the determination by the terminus decision module of the propriety of any particular specific location within the well as a drilling terminus.

32. The site computer of claim 31 wherein the sensor interface comprises at least one communications port for connection to at least one drilling sensor.

33. The site computer of claim 31 wherein the user output is an output for connection to a human interface by which the results of the assessment of the propriety of specific locations within the well as drilling termini are displayed to the operator of the remainder of the system for human interpretation and action.

34. The site computer of claim 31 wherein the user output is a drilling tool control interface between the site computer and a drilling tool, wherein adjustments or corrections to the settings of the drilling tool can be automatically communicated from the site computer based on the assessment of the drilling data contained within the drilling database.

35. The site computer of claim 31 wherein said at least one terminus decision criteria is a fixed formula, and the comparison of location-referenced drilling data thereto comprises a calculation of that formula based upon the location-referenced drilling data in question and comparing the results of that formula to a predefined range of desirable results.

36. The site computer of claim 31 wherein the terminus decision module is a fuzzy inference system capable of rendering recommendations regarding the propriety of particular specific locations within the well as desirable drilling termini based upon comparison of all of the relevant terminus decision criteria to the drilling data stored within the drilling database with respect to such specific locations.

37. The site computer of claim 31 further comprising a rules database within which said at least one terminus decision criteria is stored.

38. The system of claim 19 wherein the terminus decision module will automatically select and apply the appropriate terminus decision criteria based upon the nature and number of drilling sensors from which drilling sensory data is being stored to the drilling database.

39. The site computer of claim 31 wherein said site computer is capable of receiving drilling data via the sensor interface for recordal to the drilling database during the operation of the terminus decision module.

40. The site computer of claim 31 wherein said site computer is capable of operating the terminus decision module during the drilling of the well by a drilling tool.

41. A computer program operative to control a site computer for use in locating a drilling terminus during the drilling of a subterranean well at a drilling site with a drilling tool, said computer program being a terminus decision module which when executed by said site computer will perform the steps of:
a. Accessing from a drilling database accessible to said site computer location-referenced sensory data obtained from sensor measurements taken at at least one specific location within the well, being drilling data;
b. Assessing the desirability of specific locations within the well as drilling termini based upon the comparison of the location-referenced drilling data with respect to each such specific location contained within the drilling database to at least one terminus decision criteria;
c. Communicating the results of the assessment of the desirability of said at least one specific location in the well as a drilling terminus to a user interface of the site computer;
wherein drilling of the well can be altered or stopped based upon the determination by the terminus decision module of the propriety of any particular specific location within the well as a drilling terminus.

42. The computer program of claim 41 wherein the step of communicating the assessment of the desirability of said at least one specific location in the well as a drilling terminus to a user interface of the site computer comprises displaying the results of said assessment via a human interface to the operator of the site computer.

43. The computer program of claim 41 wherein the step of communicating the assessment of the desirability of said at least one specific location on the well as a drilling terminus to a user interface of the site computer comprises transmitting instructions for drilling adjustments or corrections from the site computer to the drilling tool via a drilling tool control interface.

44. The computer program of claim 41 further comprising the first step of receiving sensory data from at least one drilling sensor in the well in the form of at least one sensory data stream and storing that sensory data to the drilling database in respect of the specific location at which such data was obtained.

45. The computer program of claim 41 wherein the step of assessing the desirability of certain specific locations within the well as a desirable drilling terminus is conducted by a fuzzy inference system which is a part of said computer program.

46. An add-on sensory interface for use with a computer and the computer software of claim 41, wherein a pre-existing computer could be enabled for use with the method of the present invention by the connection of said external sensor interface thereto.
